(19) United States
(12) Patent Application Publication
(10) Pub. No.: US 2026/0095798 A1
(43) Pub. Date: Apr. 2, 2026

(54) OVERHEAD REDUCTION FOR FEEDBACK ON BEAM PREDICTION RESULTS

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US)

(21) Appl. No.: 19/115,148

(22) PCT Filed: Nov. 14, 2022
(86) PCT No.: PCT/CN2022/131608

§ 371 Date: Mar. 25, 2025

(51) Int. Cl. H04W 24/10; H04B 7/06

(52) U.S. Cl. CPC H04W 24/10; H04B 7/06952

(57) ABSTRACT

Methods, systems, and devices for wireless communication are described. A user equipment (UE) may transmit a first report including a set of measurement results and a set of predicted measurement results, the first report further including an indication of one or more differences between a first set of beam identifiers associated with the set of measurement results and a second set of beam identifiers associated with the set of predicted measurement results. The UE may receive, based at least in part on the indication of the one or more differences, a grant scheduling transmission of a second report. The UE may transmit the second report according to the grant, the second report identifying a mapping of the one or more differences between the first set of beam identifiers and the second set of beam identifiers.

### CROSS REFERENCE

The present Application is a 371 national phase filing of International PCT Application No. PCT/CN2022/131608 by LI et al., entitled “OVERHEAD REDUCTION FOR FEEDBACK ON BEAM PREDICTION RESULTS,” filed Nov. 14, 2022, which is assigned to the assignee hereof, and which is expressly incorporated by reference in its entirety herein.

### TECHNICAL FIELD

The following relates to wireless communication, including overhead reduction for feedback on beam prediction results.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support overhead reduction for feedback on beam prediction results. For example, the described techniques provide for a user equipment (UE) to set a bit or flag in a first channel state information (CSI) report to indicate whether there are any differences (e.g., different or out-of-order) between beam identifiers (e.g., channel measurement result-identifier (CMR-ID)) in the actual channel measurement results and predicted channel measurement results for one or more prediction occasions. When the bit or flag is set to indicate a difference, this may trigger a grant scheduling a second CSI report to identify such differences. For example, a UE may transmit a first report (e.g., the first CSI report) to a network entity. The first report may carry or otherwise convey an indication of a set of measurement results (e.g., actual channel measurement results) and a set of predicted measurement results (e.g., predicted channel measurement results for one or more future, predicted, occasion(s)). The first report may also include a bit, flag, or field set to a value that conveys an indication that there are differences between a first set of beam identifiers (e.g., one or more CMR-IDs) for the set of measurement results and a second set of beam identifiers for the set of predicted measurement results. Examples of such differences include, but are not limited to, the CMR-ID(s) of the predicted measurement result being different or out-of-order (e.g., CMR-IDs in the second set are the same as those in the first set, but in a different order) relative to the CMR-IDs of the actual measurement results indicated in the first report.

Based on the indicated differences, the network entity receiving the first report may transmit a grant to the UE scheduling transmission of a second report. The UE may transmit the second report according to the grant and, in the second report, indicate or otherwise identify a mapping of the differences between the first and second set of beam identifiers (e.g., identify the difference or out-of-order CMR-ID(s)). For example, the second report may include the beam identifiers included in the second set of beam identifiers (e.g., a full listing showing all CMR-IDs for the predicted results indicated in the first report) or include the beam identifiers in the second set that are different from the corresponding beam identifiers in the first set (e.g., a partial listing showing only the differences). Accordingly, the UE may avoid the overhead of signaling the second set of beam identifiers (e.g., the CMR-IDs for the predicted measurement results) in the first report, and yet maintain consistency with the network entity regarding channel performance measurement and reporting procedures.

A method for wireless communication at a UE is described. The method may include transmitting a first report including a set of measurement results and a set of predicted measurement results, the first report further including an indication of one or more differences between a first set of beam identifiers associated with the set of measurement results and a second set of beam identifiers associated with the set of predicted measurement results, receiving, based on the indication of the one or more differences, a grant scheduling transmission of a second report, and transmitting the second report according to the grant, the second report identifying a mapping of the one or more differences between the first set of beam identifiers and the second set of beam identifiers.

An apparatus for wireless communication at a UE is described. The apparatus may include at least one processor and memory coupled with the at least one processor. The memory storing instructions executable by the at least one processor to cause the UE to transmit a first report including a set of measurement results and a set of predicted measurement results, the first report further including an indication of one or more differences between a first set of beam identifiers associated with the set of measurement results and a second set of beam identifiers associated with the set of predicted measurement results, receive, based on the indication of the one or more differences, a grant scheduling transmission of a second report, and transmit the second report according to the grant, the second report identifying a mapping of the one or more differences between the first set of beam identifiers and the second set of beam identifiers.

Another apparatus for wireless communication at a UE is described. The apparatus may include means for transmitting a first report including a set of measurement results and a set of predicted measurement results, the first report further including an indication of one or more differences between a first set of beam identifiers associated with the set of measurement results and a second set of beam identifiers associated with the set of predicted measurement results, means for receiving, based on the indication of the one or more differences, a grant scheduling transmission of a second report, and means for transmitting the second report according to the grant, the second report identifying a mapping of the one or more differences between the first set of beam identifiers and the second set of beam identifiers.

A non-transitory computer-readable medium storing code for wireless communication, the code comprising instructions executable by at least one processor to: transmit a first report including a set of measurement results and a set of predicted measurement results, the first report further including an indication of one or more differences between a first set of beam identifiers associated with the set of measurement results and a second set of beam identifiers associated with the set of predicted measurement results, receive, based on the indication of the one or more differences, a grant scheduling transmission of a second report, and transmit the second report according to the grant, the second report identifying a mapping of the one or more differences between the first set of beam identifiers and the second set of beam identifiers.

Some examples of the method, apparatuses, and non-transitory computer-readable medium described herein may further include operations, features, means, or instructions for performing a set of channel performance measurements to obtain the set of measurement results for the first set of beam identifiers, determining a set of predicted channel performance measurements to obtain the set of measurement results for the second set of beam identifiers, and identifying the one or more differences between the first set of beam identifiers and the second set of beam identifiers, where a bit or flag in the first report may be set to a value to indicate that the one or more differences may have been identified. Some examples of the method, apparatuses, and non-transitory computer-readable medium described herein may further include operations, features, means, or instructions for determining that one or more beam identifiers in the second set of beam identifiers may be different from beam identifiers in the first set of beam identifiers, where the one or more differences may be based on the difference of the one or more beam identifiers.

Some examples of the method, apparatuses, and non-transitory computer-readable medium described herein may further include operations, features, means, or instructions for determining that beam identifiers in the second set of beam identifiers may be in a different order in the first set of beam identifiers, where the one or more differences may be based on the different order. In some examples of the method, apparatuses, and non-transitory computer-readable medium described herein, the first report indicates the first set of beam identifiers without indicating the second set of beam identifiers. Some examples of the method, apparatuses, and non-transitory computer-readable medium described herein may further include operations, features, means, or instructions for identifying a report identifier associated with the first report and including the report identifier in the second report based on the one or more differences, where the second report includes a dynamically triggered CSI report.

Some examples of the method, apparatuses, and non-transitory computer-readable medium described herein may further include operations, features, means, or instructions for identifying a report identifier associated with the second report and including the report identifier in the first report based on the one or more differences, where the second report includes a dynamically triggered CSI report.

Some examples of the method, apparatuses, and non-transitory computer-readable medium described herein may further include operations, features, means, or instructions for identifying each beam identifier in the second set of beam identifiers and including an indication of each beam identifier in the second report based on the one or more differences, where the second report includes a medium access control-control element (MAC-CE) report.

Some examples of the method, apparatuses, and non-transitory computer-readable medium described herein may further include operations, features, means, or instructions for identifying each difference between the first set of beam identifiers and the second set of beam identifiers and including an indication of each difference in the second report based on the one or more differences, where the second report includes a MAC-CE report.

Some examples of the method, apparatuses, and non-transitory computer-readable medium described herein may further include operations, features, means, or instructions for identifying a report identifier of the first report and a transmission slot of the first report and including an indication of the report identifier, the transmission slot, or both, in the second report.

Some examples of the method, apparatuses, and non-transitory computer-readable medium described herein may further include operations, features, means, or instructions for transmitting a UE capability message indicating a support for indicating the one or more differences.

Some examples of the method, apparatuses, and non-transitory computer-readable medium described herein may further include operations, features, means, or instructions for receiving, from a network entity, a signal indicating a support for indicating the one or more differences.

Some examples of the method, apparatuses, and non-transitory computer-readable medium described herein may further include operations, features, means, or instructions for applying one or more quantization schemes to the set of measurement results, to a set of beam identifiers associated with the set of measurement results, or both, in the first report.

Some examples of the method, apparatuses, and non-transitory computer-readable medium described herein may further include operations, features, means, or instructions for identifying a quantization table associated with reporting the one or more differences and applying at least a portion of the quantization table to the set of measurement results, to a set of beam identifiers associated with the set of measurement results, or both, in the first report.

A method for wireless communication at a network entity is described. The method may include receiving a first report including a set of measurement results and a set of predicted measurement results, the first report further including an indication of one or more differences between a first set of beam identifiers associated with the set of measurement results and a second set of beam identifiers associated with the set of predicted measurement results, transmitting, based on the indication of the one or more differences, a grant scheduling transmission of a second report, and receiving the second report according to the grant, the second report identifying a mapping of the one or more differences between the first set of beam identifiers and the second set of beam identifiers.

An apparatus for wireless communication at a network entity is described. The apparatus may include at least one processor, and memory coupled with the at least one processor, the memory storing instructions executable by the at least one processor to cause the network entity to: receive a first report including a set of measurement results and a set of predicted measurement results, the first report further including an indication of one or more differences between a first set of beam identifiers associated with the set of measurement results and a second set of beam identifiers associated with the set of predicted measurement results, transmit, based on the indication of the one or more differences, a grant scheduling transmission of a second report, and receive the second report according to the grant, the second report identifying a mapping of the one or more differences between the first set of beam identifiers and the second set of beam identifiers.

Another apparatus for wireless communication at a network entity is described. The apparatus may include means for receiving a first report including a set of measurement results and a set of predicted measurement results, the first report further including an indication of one or more differences between a first set of beam identifiers associated with the set of measurement results and a second set of beam identifiers associated with the set of predicted measurement results, means for transmitting, based on the indication of the one or more differences, a grant scheduling transmission of a second report, and means for receiving the second report according to the grant, the second report identifying a mapping of the one or more differences between the first set of beam identifiers and the second set of beam identifiers.

A non-transitory computer-readable medium storing code for wireless communication, the code comprising instructions executable by at least one processor to: receive a first report including a set of measurement results and a set of predicted measurement results, the first report further including an indication of one or more differences between a first set of beam identifiers associated with the set of measurement results and a second set of beam identifiers associated with the set of predicted measurement results, transmit, based on the indication of the one or more differences, a grant scheduling transmission of a second report, and receive the second report according to the grant, the second report identifying a mapping of the one or more differences between the first set of beam identifiers and the second set of beam identifiers.

Some examples of the method, apparatuses, and non-transitory computer-readable medium described herein may further include operations, features, means, or instructions for determining, based on the indication of the one or more differences, that one or more beam identifiers in the second set of beam identifiers may be different from beam identifiers in the first set of beam identifiers, where the one or more differences may be based on the difference of the one or more beam identifiers. Some examples of the method, apparatuses, and non-transitory computer-readable medium described herein may further include operations, features, means, or instructions for determining, based on the indication of the one or more differences, that beam identifiers in the second set of beam identifiers may be in a different order in the first set of beam identifiers, where the one or more differences may be based on the different order.

In some examples of the method, apparatuses, and non-transitory computer-readable medium described herein, the first report indicates the first set of beam identifiers without indicating the second set of beam identifiers. Some examples of the method, apparatuses, and non-transitory computer-readable medium described herein may further include operations, features, means, or instructions for determining that a report identifier associated with the first report may be included in the second report based on the one or more differences, where the second report includes a dynamically triggered CSI report. Some examples of the method, apparatuses, and non-transitory computer-readable medium described herein may further include operations, features, means, or instructions for determining that a report identifier associated with the second report may be included in the second report based on the one or more differences, where the second report includes a dynamically triggered CSI report.

Some examples of the method, apparatuses, and non-transitory computer-readable medium described herein may further include operations, features, means, or instructions for determining that an indication of each beam identifier in the second set of beam identifiers may be included in the second report based on the one or more differences, where the second report includes a MAC-CE report. Some examples of the method, apparatuses, and non-transitory computer-readable medium described herein may further include operations, features, means, or instructions for determining that an indication of each difference between the first set of beam identifiers and the second set of beam identifiers may be included in the second report based on the one or more differences, where the second report includes a MAC-CE report.

In some examples of the method, apparatuses, and non-transitory computer-readable medium described herein, identifying, based on the second report, a report identifier of the first report, a transmission slot of the first report, or both. Some examples of the method, apparatuses, and non-transitory computer-readable medium described herein may further include operations, features, means, or instructions for receiving a UE capability message indicating a support for indicating the one or more differences. Some examples of the method, apparatuses, and non-transitory computer-readable medium described herein may further include operations, features, means, or instructions for transmitting a signal indicating a support for indicating the one or more differences.

Some examples of the method, apparatuses, and non-transitory computer-readable medium described herein may further include operations, features, means, or instructions for applying one or more quantization schemes to the set of measurement results, to a set of beam identifiers associated with the set of measurement results, or both, indicated in the first report. Some examples of the method, apparatuses, and non-transitory computer-readable medium described herein may further include operations, features, means, or instructions for identifying a quantization table associated with reporting the one or more differences and applying at least a portion of the quantization table to the set of measurement results, to a set of beam identifiers associated with the set of measurement results, or both, indicated in the first report.

### BRIEF DESCRIPTION OF THE DRAWINGS

FIG. 1 illustrates an example of a wireless communications system that supports overhead reduction for feedback on beam prediction results in accordance with one or more aspects of the present disclosure.

FIG. 2 illustrates an example of a wireless communications system that supports overhead reduction for feedback on beam prediction results in accordance with one or more aspects of the present disclosure.

FIG. 3 illustrates an example of a report configuration that supports overhead reduction for feedback on beam prediction results in accordance with one or more aspects of the present disclosure.

FIGS. 4A and 4B illustrate examples of a report configurations that supports overhead reduction for feedback on beam prediction results in accordance with one or more aspects of the present disclosure.

FIGS. 5A-5C illustrate examples of a report configurations that supports overhead reduction for feedback on beam prediction results in accordance with one or more aspects of the present disclosure.

FIGS. 6 and 7 illustrate block diagrams of devices that support overhead reduction for feedback on beam prediction results in accordance with one or more aspects of the present disclosure.

FIG. 8 illustrates a block diagram of a communications manager that supports overhead reduction for feedback on beam prediction results in accordance with one or more aspects of the present disclosure.

FIG. 9 illustrates a diagram of a system including a device that supports overhead reduction for feedback on beam prediction results in accordance with one or more aspects of the present disclosure.

FIGS. 10 and 11 illustrate block diagrams of devices that support overhead reduction for feedback on beam prediction results in accordance with one or more aspects of the present disclosure.

FIG. 12 illustrates a block diagram of a communications manager that supports overhead reduction for feedback on beam prediction results in accordance with one or more aspects of the present disclosure.

FIG. 13 illustrates a diagram of a system including a device that supports overhead reduction for feedback on beam prediction results in accordance with one or more aspects of the present disclosure.

FIGS. 14 through 18 illustrate flowcharts showing methods that support overhead reduction for feedback on beam prediction results in accordance with one or more aspects of the present disclosure.

### DETAILED DESCRIPTION

Wireless networks may use channel measurement and reporting procedures (e.g., channel state information (CSI) reporting) to monitor the performance of the wireless channel being used, or potentially to be used, for wireless communications. Such techniques may improve allocation and configuration decisions associated with the wireless communications, as well as mobility (e.g., handover) within the network. This may include a user equipment (UE) transmitting measurement reports indicating the results of channel measurements the UE has performed using reference signals, synchronization signals, tracking signals, or other signals transmitted by the network entity (e.g., measuring signal(s) transmitted over the channel and reporting the results of those measurements, such as the reference signal received power (RSRP)) as well as predicted measurement results. The predicted results may generally identify (e.g., based on past measurements, anticipated movement, anticipated communications, or other considerations) what performance the UE expects the channel to provide during the predicted occasion(s). However, the predicted measurements are generally signaled with full identifying information (e.g., beam identifiers, such as the channel measurement result-identifier (CMR-ID) for each reported RSRP) for both the actual measurement results as well as the predicted measurement results. The overhead used to support signaling identifying information for both actual and predicted measurement results is significant, and may be unnecessary in some situation.

Accordingly, the described techniques provide for a UE to set a bit or flag in a first CSI report to indicate whether there are any differences (e.g., different or out-of-order) between beam identifiers (e.g., CMR-ID) in the actual channel measurement results and predicted channel measurement results for one or more prediction occasions. When the bit or flag is set to indicate a difference, this may trigger a grant scheduling a second CSI report to identify such differences. For example, a UE may transmit a first report (e.g., the first CSI report) to a network entity. The first report may carry or otherwise convey an indication of a set of measurement results (e.g., actual channel measurement results) and a set of predicted measurement results (e.g., predicted channel measurement results for one or more future, predicted, occasion(s)). The first report may also include a bit, flag, or field set to a value that conveys an indication that there are differences between a first set of beam identifiers (e.g., one or more CMR-IDs) for the set of measurement results and a second set of beam identifiers for the set of predicted measurement results. Examples of such differences include, but are not limited to, the CMR-ID(s) of the predicted measurement result being different or out-of-order (e.g., CMR-IDs in the second set are the same as those in the first set, but in a different order) relative to the CMR-IDs of the actual measurement results indicated in the first report.

Based on the indicated differences, the network entity receiving the first report may transmit a grant to the UE scheduling transmission of a second report. The UE may transmit the second report according to the grant and, in the second report, indicate or otherwise identify a mapping of the differences between the first and second set of beam identifiers (e.g., identify the difference or out-of-order CMR-ID(s)). For example, the second report may include the beam identifiers included in the second set of beam identifiers (e.g., a full listing showing all CMR-IDs for the predicted results indicated in the first report) or include the beam identifiers in the second set that are different from the corresponding beam identifiers in the first set (e.g., a partial listing showing only the differences). Accordingly, the UE may avoid the overhead of signaling the second set of beam identifiers (e.g., the CMR-IDs for the predicted measurement results) in the first report, and yet maintain consistency with the network entity regarding channel performance measurement and reporting procedures.

Aspects of the disclosure are initially described in the context of wireless communications systems. Aspects of the disclosure are further illustrated by and described with reference to apparatus diagrams, system diagrams, and flowcharts that relate to overhead reduction for feedback on beam prediction results.

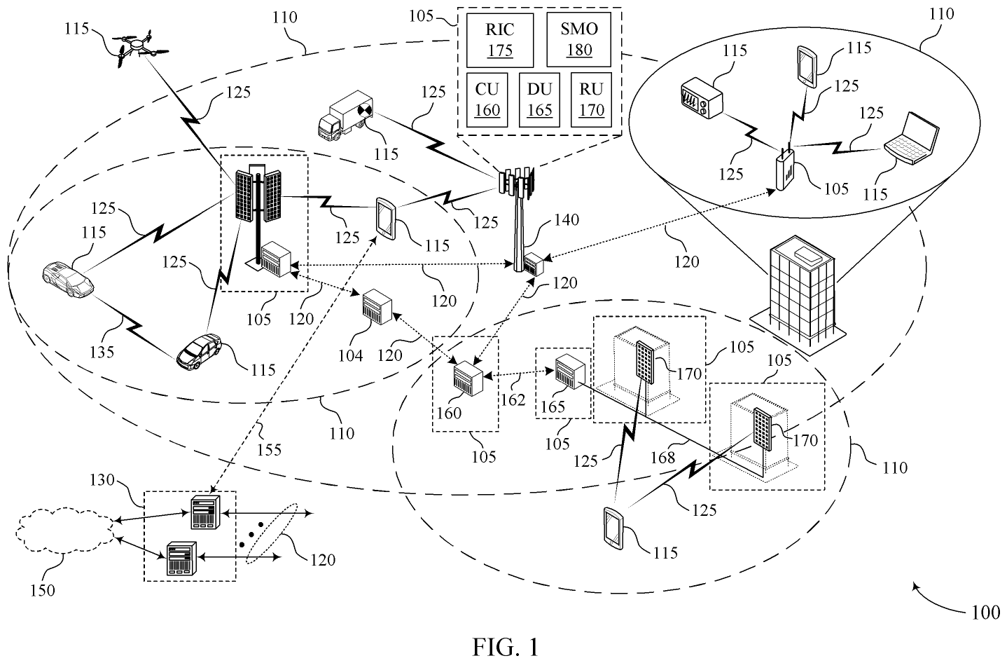

FIG. 1 illustrates an example of a wireless communications system 100 that supports overhead reduction for feedback on beam prediction results in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support overhead reduction for feedback on beam prediction results as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IOT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat MI) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IOT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may also operate using a super high frequency (SHF) region, which may be in the range of 3 GHz to 30 GHZ, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may transmit a first report including a set of measurement results and a set of predicted measurement results, the first report further including an indication of one or more differences between a first set of beam identifiers associated with the set of measurement results and a second set of beam identifiers associated with the set of predicted measurement results. The UE 115 may receive, based at least in part on the indication of the one or more differences, a grant scheduling transmission of a second report. The UE 115 may transmit the second report according to the grant, the second report identifying a mapping of the one or more differences between the first set of beam identifiers and the second set of beam identifiers.

A network entity 105 may receive a first report including a set of measurement results and a set of predicted measurement results, the first report further including an indication of one or more differences between a first set of beam identifiers associated with the set of measurement results and a second set of beam identifiers associated with the set of predicted measurement results. The network entity 105 may transmit, based at least in part on the indication of the one or more differences, a grant scheduling transmission of a second report. The network entity 105 may receive the second report according to the grant, the second report identifying a mapping of the one or more differences between the first set of beam identifiers and the second set of beam identifiers.

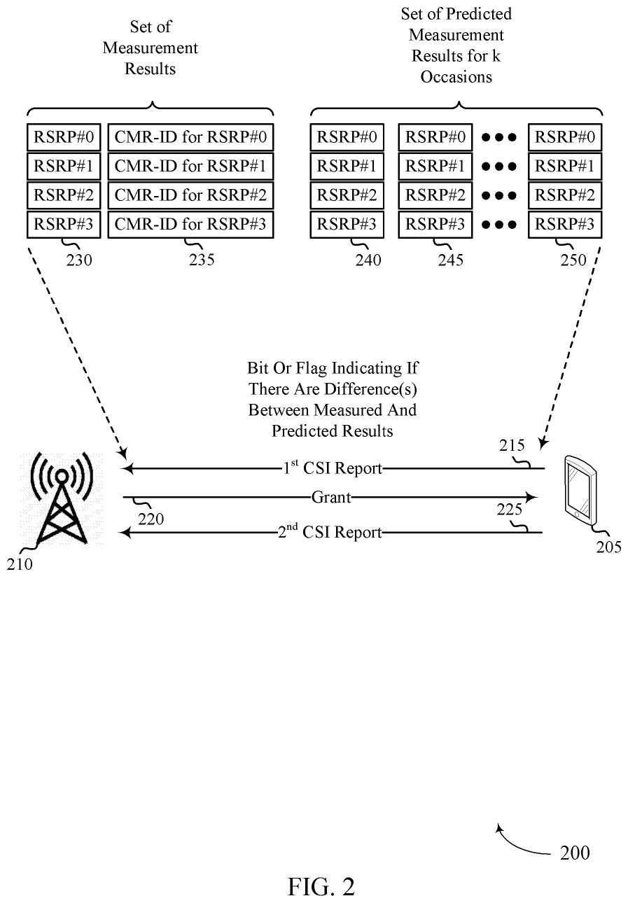

FIG. 2 illustrates an example of a wireless communications system 200 that supports overhead reduction for feedback on beam prediction results in accordance with one or more aspects of the present disclosure. Wireless communications system 200 may implement aspects of wireless communications system 100. Wireless communications system 200 may include a UE 205 and a network entity 210, which may be examples of the corresponding devices described herein.

Wireless communications systems use channel measurement and reporting procedures (e.g., CSI reporting, L1 reporting, L2 reporting, or L3 reporting) to monitor channel performance. The reporting procedures generally include the UE 205 measuring reference signal(s) transmitted by the network entity 210, or vice versa. The measurements may include measuring, identifying, or otherwise determining an RSRP, a reference signal strength indicator (RSSI), an interference level, or a throughput, for the channel. The UE 205 may modify one or more allocation decisions, configurations, or other parameters used for wireless communications based on the measurement results. The UE 205 may also transmit or otherwise provide an indication of the measurement results to the network entity 210, which may also modify one or more allocation decisions, configuration, or other parameters.

In some aspects, the CSI reporting may be used for beam management within the wireless network. The UE 205 and/or the network entity 210 may use beamformed or directional communications to steer a beamed wireless transmission in a particular direction, such as toward the receiving device. While beamformed communications are useful techniques to improve communications, management of the beams being used is important due to mobility, interference, blockage, user actions, and so forth. The beamformed communications may include the transmitting device using transmit beam(s) to transmit towards the receiving device and the receiving device using receive beam(s) to receive the transmissions. Accordingly, a beam pair may include a transmit beam of the transmitting device and the receive beam of the receiving device.

Beam management techniques (which may be considered part of CSI reporting procedures) have evolved over the course of wireless network development. For example, wireless networks may support beam management while the UE 205 is operating in a radio resource control (RRC) idle or inactive state or during initial network access by the UE 205 (e.g., using beam sweeping techniques for synchronization signal block (SSB) transmissions). Beam management techniques are also implemented for the UE 205 while operating in an RRC connected state, which may include provisions for detecting and recovering from a beam failure.

Wireless communications systems may support advanced CSI reporting techniques, such as improved beam management techniques using artificial intelligence (AI) and/or machine learning techniques. This may support beam prediction improvements in the time and/or spatial domain based on modeling predicted beam performance. Such beam modeling techniques generally provide a spatial or temporal beam prediction for a set of beams based on current and/or historical beam measurements for a different set of beams. In some examples, the predicted beam set may have narrower beams relative to the measured beams.

However, such techniques are generally limited in scope and add considerable overhead to the wireless network. For example, such techniques are generally limited to reporting the predicted beam results for a single time instance (e.g., for one prediction occasion), which may not provide sufficient information to accurately predict future channel/beam performance over time. Moreover, such techniques increase the latency for predicted-based beam management as the network waits for multiple CSI reports to gather sufficient prediction occasions to accurately model the channel/beam performance. Additionally and as such techniques report a single predicted beam measurement for a single prediction occasion, wireless networks may not support or otherwise define how predicted beam measurements for multiple prediction occasions are to be reported, such as what information is to be reported for each predicted measurement, how each predicted measurement is reported relative to other predicted measurements (e.g., absolute values, referential values, quantization, and so forth).

Furthermore, such techniques may not support or otherwise define how differences between actual measurement results and predicted measurement results are reported. For example, wireless networks do not provide a mechanism or otherwise define correspondence between the actual measurement results and the predicted measurement results. As is understood in the art, a one-to-one correspondence requirement may be helpful in some scenarios, but limit the CSI reporting such that potentially better channel/beam performance candidates can be identified and reported. Alternatively, an absence of any correspondence requirement between the measured and predicted results may result in a large increase in overhead as details of each predicted measurement result for each prediction occasion are reported.

More particularly, the UE 205 may use a layer one (L1)-report to feed back predicted and measured RSRPs periodically (e.g., measuring every anchor 80 ms occasions while predicting RSRPs for the every-20-ms prediction occasions between anchor occasions, assuming an identical number of beams are addressed for each prediction/measurement occasion). In some aspects, the overhead may be potentially reduced considering beam change predictions for some scenarios. As one non-limiting example, for a pedestrian walking speed without frequent UE rotation, it may be more likely that the beams reported for the most recent measurement cycle may be the top (e.g., same) beams for the following prediction occasions. The overhead to report the beam-IDs for prediction cycles may be potentially reduced (e.g., if 64 beams are included in the CMR set, reporting a certain CMR-ID requests 6 bits for each predicted beam. In other situations, the opposite might happen (e.g., the UE may be moving at a high mobility rate or otherwise experience frequency channel performance changes). Such techniques may not allow such occasional payload (e.g., differing predicted occasions and/or predicted information) to be efficiently reported by the UE 205.

Accordingly, aspects of the techniques described herein provide various mechanisms that support reporting actual measurement results (e.g., a set of measurement results) and a set of predicted measurement results. The set of predicted measurement result may include multiple prediction occasions (e.g., for k prediction occasions). The report may also include a bit, flag, field, or parameter set to a value to carry or otherwise convey an indication of whether there is a difference between the currently reported measurements and the predicted measurements. That is, the UE 205 may determine that there are difference(s) between the beam identifiers indicated for the actual measurement results (with the CMR-IDs and associated measurement results being indicated) and the predicted measurement results (with the predicted results, but not the CMR-IDs for the predicted results are indicated). The UE 205 may provide an indication that there are differences, but not necessarily an indication of what the differences are. In other situations the UE 205 may use two or more bits to convey at least certain information regarding the differences. For example, the bits may be set to a first value (e.g., “00”) to indicate no differences, to a second value (e.g., “01”) to indicate that there is a difference in ordering, or to a third value (e.g., “10”) to indicate that there is a difference in the beam identifiers in the sets.

In some aspects, this may include a persistent or semi-persistent L1 report including the measured RSRPs (e.g., the measurement results) with respect to the top-N beams at the associated measurement occasion, plus ktime-domain prediction occasions (after the measurement occasion) of predicted RSRPs, each predicted RSRP associated with also top-N beams. An additional bit may be included in the L1 report. In some examples, when “0” is indicated in the first report, this may indicate that the beams addressed for prediction occasions (e.g., the beam identifiers, such as the CMR-IDs associated with the predicted RSRPs) are supposed to be identical (e.g., the same as) as the ones included in the measurement occasion. When “1” is indicated in the first report, this may indicate that the beams addressed for prediction occasions are supposed to be different (at least one prediction occasion) . This may signal to the network entity 210 that the UE 205 expects to be triggered with a dynamic CSI report or to use a medium access control-control element (MAC-CE) to report beam-IDs regarding such difference(s). Quantization schemes for the proposed reporting framework are also described herein.

Accordingly, at 215 the UE 205 may transmit or otherwise provide a first report to the network entity 210 that carries or otherwise conveys an indication of a set of measurement results and a set of predicted measurement results. The set of measurement results may generally refer to the measurements determined during a measurement occasion using signal(s) transmitted by the network entity 210 over the wireless channel. For example, the UE 205 may perform a set of channel performance measurements to measure, identify, or otherwise obtain the set of measurement results for the first set of beam identifiers. This may include the UE 205 measuring each measurement resource (e.g., each measurement resource, shown as RSRP #0-3) to determine the RSRP for the resource. The UE 205 may measure each measurement resource during a measurement occasion.

The set of measurement results may include both the measurement result 230 and the beam identifier 235 for the corresponding measurement result 230. That is, each measurement occasion may generally be associated with time, frequency, spatial, or code resources (e.g., measurement resources) that the UE 205 is to monitor for measuring the signal. The measurement occasion may have a corresponding identifier (e.g., CMR-ID) that identifies the measurement occasion and/or resource and is used to identify the measurement result being reported by the UE 205. The resources may include one or more beams associated with the channel measurement(s), where each beam has a corresponding beam identifier. Thus, the CMR-ID may correspond to beam identifier(s) associated with the reported measurement result 230 (e.g., the reported RSRP). In the non-limiting example illustrated in FIG. 2, four measurement results are included in the set of measurements (e.g., corresponding to RSRP 0-3) for the measurement occasion, although a different number may be measured and reported.

The set of predicted measurement results (or simply predicted result or predicted RSRP) may include a predicted measurement result for multiple prediction occasions. The UE 205 may identify or otherwise determine the set of predicted measurement results based on a corresponding set of predicted channel performance metrics (e.g., expected RSRP for the resource during the prediction occasion) for the second set of beam identifiers. The predicted channel performance metrics may be based on the set of current measurements, historical measurements (previously reported or not), anticipated movement of the UE 205, or anticipated communications of the UE 205. The UE 205 may use one or more AI or machine learning protocols to determine the set of predicted measurement results for each prediction occasion.

For example, the set of predicted measurement results may include a predicted result 240 for a first prediction occasion, a predicted result 245 for a second prediction occasion, and a predicted result 250 for a final prediction occasion, for a total of k prediction occasions. Each predicted result may generally carry or otherwise convey an indication of the predicted RSRP or other channel performance metric during the prediction occasion, again with four predicted results (e.g., for RSRP #0-3) during each prediction occasion being shown by way of non-limiting example.

The first report may indicate the set of predicted measurement results for the prediction occasions, but may not necessarily indicate the corresponding beam identifier for each predicted result. That is, unlike the set of measurement results where the measurement result and the corresponding beam identifier(s) (e.g., the CMR-IDs, which may be associated with the beam identifier(s) for the RSRP measurement resource) are included in the first report, there is no indication of a second set of beam identifiers associated with the set of predicted measurement results in the first report. Instead, the first report may carry or otherwise convey an indication of whether there is a difference between the first set of beam identifiers associated with the set of measurement results and the second set of beam identifiers associated with the set of predicted measurement results.

For example, the UE 205 may identify or otherwise determine whether there are difference(s) between the first set of beam identifiers (e.g., one of more of beam identifier 235) associated with, and indicated for, the set of measurement results and the second set of beam identifiers for the set of predicted measurement results. For example, the UE 205 may identify or otherwise determine whether the first set of beam identifiers is the same as the second set of beam identifiers, or different.

A difference may be based on a difference in beam identifiers between the first and second sets of beam identifiers. For example, a CMR-ID and/or associated beam identifier in the first set of beam identifiers may be different from the CMR-ID and/or associated beam identifier in the second set of beam identifiers. This may indicate that the predicted result for the prediction occasion is associated with a different CMR-ID and/or at least one of the beam identifiers associated with the CMR-ID than is being reported in the first report.

The difference may be based on a different ordering of the beam identifiers in the first and second sets of beam identifiers. For example, the UE 205 may identify or otherwise determine that the beam identifiers in the second set of beam identifiers may be in a different order in the first set of beam identifiers. That is, the beam identifiers in the first and second sets of beam identifiers may be the same (e.g., all for RSRP #0-3), but the order of predicted result for the beam identifier is different than in the first set of measurement results.

Accordingly, the UE 205 may use a bit or bits, a flag, a field, and/or a parameter set to a value to carry or otherwise convey an indication of whether or not there is a difference between the first set of beam identifiers and the second set of beam identifiers. In some examples, this may include the first report indicating “0” to convey that there are no differences or “1” to convey that there are differences between the first set of beam identifiers and the second set of beam identifiers. Thus, the UE 205 may transmit the first report indicating the measurement result 230 and corresponding beam identifier 235 for the set of measurement results, along with the predicted result for multiple prediction occasions (e.g., the set of predicted measurement results), but without indicating the second set of beam identifiers for the set of predicted measurement results.

In response and at 220, the network entity 210 may transmit or otherwise provide a grant to the UE 205 scheduling transmission of a second report (e.g., dynamic CSI report and/or MAC-CE based report). In some aspects, the grant may be transmitted when the first report indicates that there is a difference between the first set of beam identifiers and the second set of beam identifiers. That is, the first report indicating a difference may trigger scheduling of the second report.

Thus, at 225 the UE 205 may transmit or otherwise provide a second report (e.g., a second CSI report) to the network entity 210. The second report may carry or otherwise convey an indication of a mapping of the difference(s) between the first set of beam identifiers in the set of measurement results and the second set of beam identifiers associated with the set of predicted measurement results.

Thus, wireless communications system 200 provides for joint measurement and predicted L1 reporting without beam-IDs for the prediction cycles. This may be based on a first CSI report where the UE 205 reports L1-RSRPs/L1-signal-to-interference-plus-noise ratios (SINRs) regarding N CMRs (with N=4 in FIG. 2, corresponding to RSRP #0-3) associated with a CSI report setting regarding (k+1) time domain occasions (e.g., prediction occasions), where an additional bit is included in the CSI Report. The L1-RSRPs/L1-SINRs for the first time domain occasion (e.g., the measurement occasion) are based on actual measurements whose CSI reference resource is no later than the slot carrying the first CSI report. The CMR-IDs (e.g., the first set of beam identifiers) associated with the L1-RSRPs/L1-SINRs for the first time domain occasion are also included in the first CSI report. The L1-RSRPs/L1-SINRs (e.g., the set of measurement results) for the k time domain occasions (prediction occasions) may be based on the UE 205 prediction, where such ktime domain occasions are at least after the slot carrying the CSI report. The first CSI report may carry or otherwise convey an additional bit used to indicate whether is a difference between the first set of beam identifiers (e.g., the CMR-IDs associated with the L1-RSRP/L1-SINRs) and the second set of beam identifiers for the k time domain prediction occasions (e.g., for the set of predicated measurement results).

If “0” is reported in the first CSI report, the L1-RSRPs/L1-SINRs with respect to the k prediction occasions are associated with identical CMRs as that in the first time domain occasion based on actual measurements, while their CMR-ID orders are also identical as that associated with the first time domain occasion. If “1” is reported in the first CSI report, this may indicate that there is at least one prediction occasion out of the k prediction occasions, wherein the L1-RSRPs/L1-SINRs for such a prediction occasion are associated with a CMR that is not addressed by the first time domain occasion, or the CMR-ID order of such a prediction occasion is different from that associated with the first time domain occasion.

If “1” is reported in the first CSI report, this may trigger the second CSI report that carries or otherwise conveys an indication identifying a mapping of the differences. The mapping may be a full mapping of the second set of beam identifiers or a partial mapping showing the different beam identifiers in the second set of beam identifiers. Thus, this may provide an efficient mechanism for the UE 205 to report RSRP/SINR for multiple prediction occasions along with current RSRP/SINR measurement results and also to indicate whether there are any differences (e.g., different or out-of-order) between the beam identifiers for the predicted results and the corresponding current measurement result. If “0” is reported in the first CSI report, the second CSI report may be unnecessary (e.g., at least relative to reporting a mapping of differences).

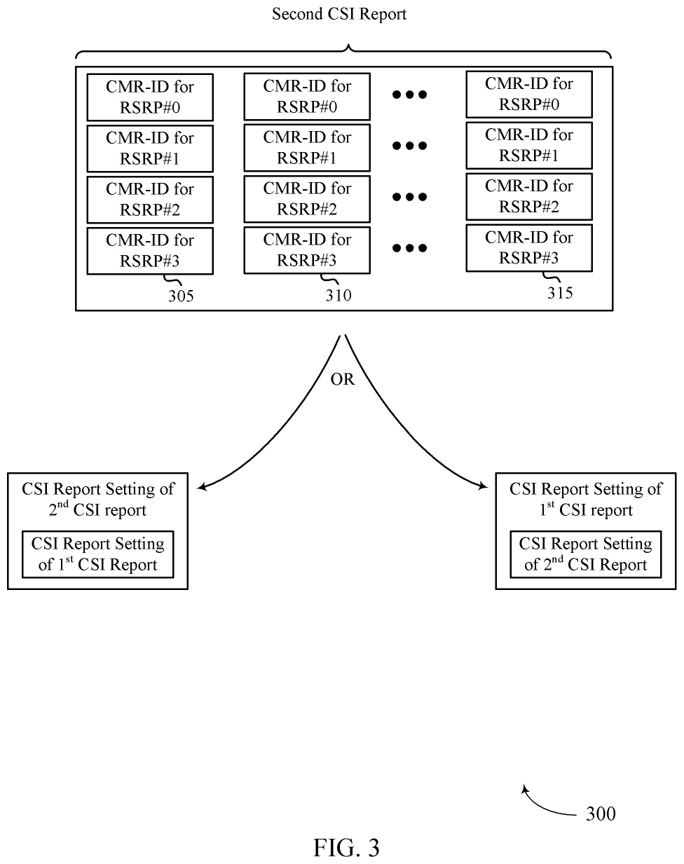

FIG. 3 illustrates an example of a report configuration 300 that supports overhead reduction for feedback on beam prediction results in accordance with one or more aspects of the present disclosure. Report configuration 300 may implement aspects of wireless communications systems 100 and/or 200. Aspects of report configuration 300 may be implemented at or implemented by a UE and/or network entity, which may be examples of the corresponding devices described herein. Report configuration 300 illustrates a non-limiting example of a second CSI reporting identifying a mapping of difference(s) between a first set of beam identifiers and a second set of beam identifiers. In some aspects, report configuration 300 illustrates an example where the second report is a dynamically triggered CSI report (e.g., an aperiodic CSI report).

As discussed herein, the described techniques provide efficient techniques for a UE to report a set of measurement results (e.g., L1-RSRP/SINR) and the associated first set of beam identifiers (e.g., CMR-IDs) for the set of measurement results, along with a set of predicted measurement results in a first CSI report sent to a network entity. The first CSI report may also include a bit or bits, a flag, a field, and/or a parameter set to a value to indicate whether there are any differences between the first set of beam identifiers (e.g., as reported in the first CSI report) and a second set of beam identifiers (e.g., CMR-IDs) for the set of predicted measurement results, without reporting the second set of beam identifiers. As one non-limiting example, if “0” is reported in the first CSI report, this may indicate that there are no differences and if “1” is reported this may indicate that there are differences. If there are differences, this may trigger a grant scheduling a second CSI report that identifies a mapping of the differences. That is, if “1” is reported for the additional bit in the first CSI report, this may indicate that at least one of the CMR-ID (or its relative order) is different from the corresponding CMR-ID for the first time domain occasion (e.g., the measurement occasion for the set of measurement results). Report configuration 300 illustrates a non-limiting example of the second CSI report identifying the mapping of the differences between first set of beam identifiers and the second set of beam identifiers.

In particular, report configuration 300 illustrates an example second CSI report identifying the mapping of the differences. When “1” was reported, the UE expects (e.g., based on indicating “1” in the first CSI report) to be triggered (e.g., via a grant) with a second aperiodic or dynamic CSI report to feed back (e.g., identify the mapping) the CMR-IDs (e.g., the second set of beam identifiers) for the k time domain occasions (e.g., the k prediction occasions). In some aspects, the second CSI report may have a fixed payload size, such as to support providing a listing of the second set of beam identifiers.

For example, the UE is expected to be triggered with a second aperiodic CSI report, wherein the report quantity of the second CSI report should include at least the CMR-IDs associated with the L1-RSRPs/L1-SINRs (the set of predicted measurement results) for the k prediction occasions (e.g., for the most recently UE reported first CSI report indicating the set of measurement results when the additional bit was indicated as “1”). Thus, the second CSI report in this example may include a beam identifier 305 for the first prediction occasion, a beam identifier 310 for the second prediction occasion, and a beam identifier 315 for a third prediction occasion, again with four beam identifiers being reported for each previously reported prediction occasion by way of non-limiting example. That is, each beam identifier for the predicted measurement result in the set of predicted measurement results may be identified in the second CSI report. The network entity may compare the second set of beam identifiers (e.g., the CMR-IDs) for the set of measurement results indicated in the first CSI report to the second set of beam identifiers (e.g., CMR-IDs) indicated in the second CSI report for the set of predicted measurement results reported in the first CSI report to determine or otherwise identify such differences. As discussed above, the differences may be different beam identifiers (e.g., CMR-IDs) and/or that one or more of the beam identifiers in the second set of beam identifiers is in a different order in the first set of beam identifiers.

In some examples, the first and second CSI reports may be tied together or otherwise associated with each other based on report identifiers (e.g., CSI report IDs). For example, the UE may identify or otherwise determine a report identifier of the first report and include the report identifier of the first report in the second report. For example, the CSI report setting ID of the first CSI report may be included in the CSI report setting of the second CSI report, or included in the CSI-AssociatedReportConfigInfo for the second AP CSI report.

Additionally, or alternatively, the UE may identify or otherwise determine a report identifier of the second report and include the report identifier of the second report in the first report. For example, the CSI report setting ID of the second CSI report (e.g., the second aperiodic or dynamically triggered CSI report) is included in the CSI report setting of the first CSI report, or the {CSI-AssociatedReportConfigInfo ID, CSI-AperiodicTriggerState ID} of the second CSI report is included in the CSI report setting of the first CSI report. Through such linkage, the UE knows which first CSI report it should refer to when it is triggered with the second CSI report. Such linkage may also be used by the network entity to know which first CSI report it should refer to upon receiving the second CSI report to determine the differences between the beam identifiers.

In some examples, the report identifier as well as other information (e.g., transmission slot) for the first CSI report may be indicated in the second CSI report. That is, the CSI report setting ID of the first CSI report and/or the slot/subframe/frame-ID associated with the slot/subframe/frame carrying the first CSI report may also be optionally included in the second CSI report (e.g., to avoid ambiguity when there are multiple first CSI reports with “1” reported, or there are first CSI reports that have been missed by the network entity).

In some examples, how to configure the second CSI report may be based on UE capability reporting and/or separately configured by the network. For example, the UE may transmit or otherwise provide a UE capability message indicating support for indicating the differences (e.g., in a second CSI report conveyed in a dynamically triggered CSI report and/or in a MAC-CE report). The network entity may use the UE capability for CSI reporting where there are differences between the measured and predicted measurement result beam identifiers. Additionally, or alternatively, the network entity may transmit or otherwise provide a signal configuring or otherwise indicating support for indicating the differences according to the techniques described herein.

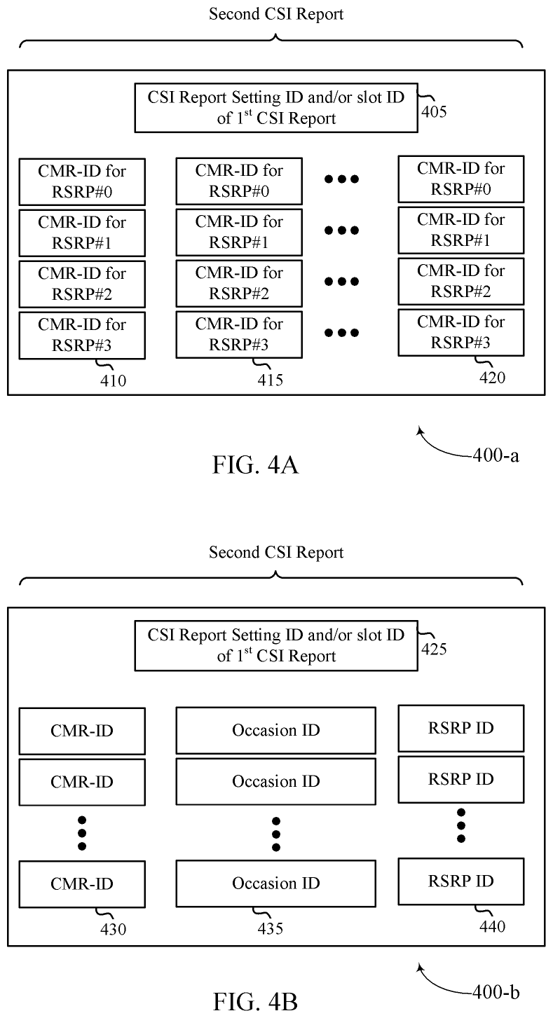

FIGS. 4A and 4B illustrate examples of report configurations 400-a and 400-b that support overhead reduction for feedback on beam prediction results in accordance with one or more aspects of the present disclosure. Report configurations 400-a and 400-b may implement aspects of wireless communications systems 100 and/or 200 and/or aspects of report configuration 300. Aspects of report configurations 400-a and 400-b may be implemented at or implemented by a UE and/or network entity, which may be examples of the corresponding devices described herein.

Report configurations 400-a and 400-b illustrate a non-limiting example of a second CSI report identifying a mapping of difference(s) between a first set of beam identifiers and a second set of beam identifiers. In some aspects, report configurations 400-a and 400-b illustrate an example where the second report is a MAC-CE report. In particular, report configuration 400-a of FIG. 4A illustrates an example of a full report indicating each beam identifier in the second set of beam identifiers where report configuration 400-b of FIG. 4B illustrates an example of a partial report indicating just the different beam identifiers in the second set of beam identifiers relative to the first set of beam identifiers.

As discussed herein, the described techniques provide efficient techniques for a UE to report a set of measurement results (e.g., L1-RSRP/SINR) and the associated first set of beam identifiers (e.g., CMR-IDs) for the set of measurement results, along with a set of predicted measurement results for multiple prediction occasions in a first CSI report sent to a network entity. The first CSI report may also include a bit or bits, a flag, a field, and/or a parameter set to a value to indicate whether there are any differences between the first set of beam identifiers (e.g., as reported in the first CSI report) and a second set of beam identifiers (e.g., CMR-IDs) for the set of predicted measurement results, without reporting the second set of beam identifiers in the first CSI report. If there are differences, this may trigger a grant scheduling a second CSI report that identifies a mapping of the differences. That is, if “1” is reported for the additional bit in the first CSI report, this may indicate that at least one of the CMR-ID (or its relative order) is different from the corresponding CMR-ID for the first time domain occasion (e.g., the measurement occasion for the set of measurement results). Report configurations 400-a and 400-b illustrate a non-limiting example of the second CSI report identifying the mapping of the differences between first set of beam identifiers and the second set of beam identifiers.

In particular, report configurations 400-a and 400-b illustrate an example second CSI report identifying the mapping of the differences. When “1” was reported and the UE dos not have an uplink grant to convey the second report, the “1” indicated in the first CSI report may act as a scheduling request (SR) informing the network entity that the UE has data to transmit (e.g., the second CSI report). In response, the network entity may receive the “indication” of the SR from the UE and respond with the grant scheduling the second report.

For example, the UE is expected to be triggered with a second aperiodic CSI report, wherein the report quantity of the second CSI report should include at least the CMR-IDs associated with the L1-RSRPs/L1-SINRs (the set of predicted measurement results) for the k prediction occasions (e.g., for the most recently UE reported first CSI report indicating the set of measurement results when the additional bit was indicated as “1”). Thus, the second CSI report in this example may include a MAC-CE report where the second report is carried or otherwise conveyed in a MAC-CE transmitted to the network entity.

In some examples, the report identifier as well as other information (e.g., transmission slot) for the first CSI report may be indicated in the second CSI report. That is, the CSI report setting ID of the first CSI report and/or the slot/subframe/frame-ID associated with the slot/subframe/frame carrying the first CSI report may also be optionally included in the second CSI report (e.g., to avoid ambiguity when there are multiple first CSI reports with “1” reported, or there are first CSI reports that have been missed by the network entity).

Accordingly and turning first to report configuration 400-a of FIG. 4A, the second report may include or otherwise convey an indication of each beam identifier (e.g., CMR-ID) in the second set of beam identifiers. For example, the second report may include a report ID 405 for the first CSI report, a beam identifier 410, a beam identifier 415, and a beam identifier 420, for each prediction occasion reported in the first CSI report. Again, there are four beam identifiers per prediction occasion shown by way of non-limiting example only. This full report mechanism provides for all respective CMR-IDs for all respective prediction occasion being included in the MAC-CE report carrying the second report. Thus the UE may identify or otherwise determine each beam identifier in the second set of beam identifiers and include the indication of each beam identifier in the second report (e.g., in the MAC-CE report). In some examples, the MAC-CE report carrying or otherwise conveying the second report may be a fixed length MAC-CE (e.g., based on the expected number of CMR-IDs to be reported in the second report based on the first report.

Turning next to report configuration 400-b of FIG. 4B, the second report may carry or otherwise convey an indication of each difference (e.g., each different beam identifier) between the first set of beam identifiers and the second set of beam identifiers (e.g., a partial report). For example, the second report may include a report identifier 425 of the first CSI report, a beam identifier 430, an occasion identifier 435, and a RSRP ID 440 for each beam identifier in the second set of beam identifiers that is different from (or out of order with) the respective predicted result indicated in the first report. That is, in this example the full listing of the second set of beam identifiers is not conveyed. Instead, the second report may include a variable length MAC-Ce that includes a flexible number (e.g., based on how many differences there are) of CMR-IDs. Each reported CMR-ID (e.g., beam identifier) is accompanied by the prediction occasion identifier and the L1-RSRP/L1-SINR order identifier for the associated prediction occasion. This information may serve to map the predicted result(s) reported as the set of predicted measurement results in the first report that are different from the respective beam identifiers in the first set of beam identifiers for the set of measurement results. This approach may improve the efficiency of the second report by reporting a reduced amount of information in the second report (e.g., the partial report only identifying each difference relative to the first report).

In some aspects, which MAC-CE report format (e.g., fixed or flexible length) may be based on the number of differences between the first set of beam identifiers and the second set of beam identifiers. That is, the UE may determine the number of differences and include an indication of the amount of information to be conveyed in the second report via the SR (e.g., a large amount of data for the full reporting or a small data indicator when only a partial reporting is warranted). Accordingly, the network entity may more efficiently allocate resources for the second report based on the number of differences between the first and second sets of beam identifiers.

Again, how to configure the second CSI report may be based on UE capability reporting and/or separately configured by the network. For example, the UE may transmit or otherwise provide a UE capability message indicating support for indicating the differences (e.g., in a second CSI report conveyed in a dynamically triggered CSI report and/or in a MAC-CE report). The network entity may use the UE capability for CSI reporting where there are differences between the measured and predicted measurement result beam identifiers. Additionally, or alternatively, the network entity may transmit or otherwise provide a signal configuring or otherwise indicating support for indicating the differences according to the techniques described herein.

Accordingly, report configurations 400-a and 400-b illustrate non-limiting examples of how a UE uses an uplink MAC-CE to feed back the CMR-IDs for the k time domain occasions (e.g., for the prediction occasions). In report configuration 400-a, the second report (e.g., the MAC-CE report) includes an indication of all CMR-IDs for each of the k time domain prediction occasions. In report configuration 400-b, the flexible payload MAC-CE may be used to indicate each CMR-ID accompanied with its occasion identifier and RSRP order identifier.

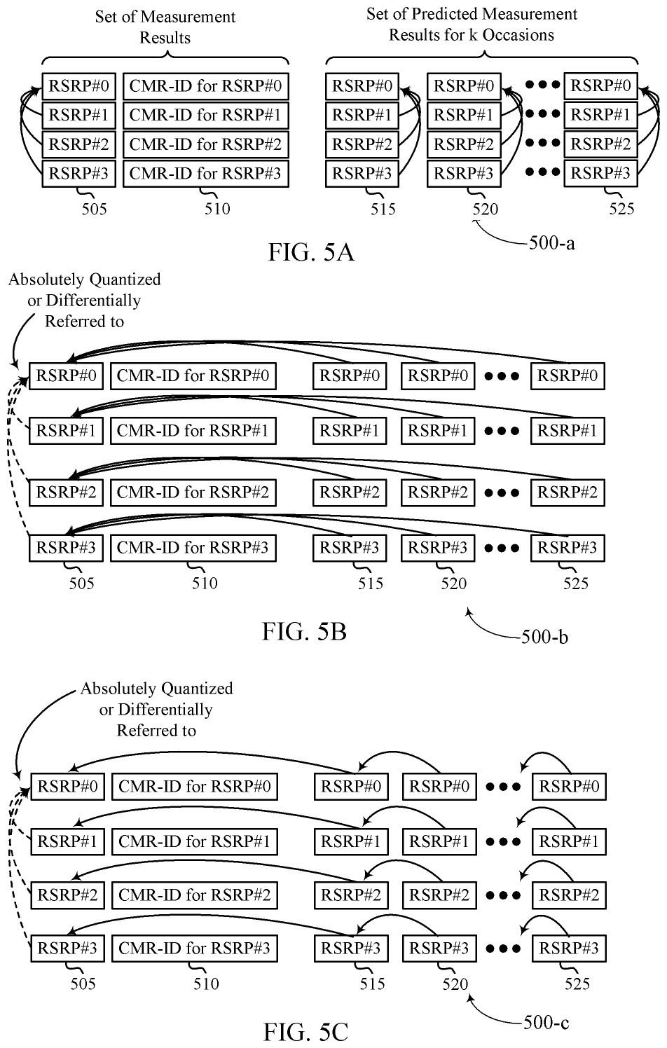

FIGS. 5A-5C illustrate examples of report configurations 500-a, 500-b, and 500c that support overhead reduction for feedback on beam prediction results in accordance with one or more aspects of the present disclosure. Report configurations 500-a, 500-b, and 500-c may implement aspects of wireless communications systems 100 and/or 200 and/or aspects of report configurations 300, 400-a and/or 400-b. Aspects of report configurations 500-a, 500-b, and 500-c may be implemented at or implemented by a UE and/or network entity, which may be examples of the corresponding devices described herein.

Report configuration 500-a of FIG. 5A, report configuration 500-b of FIG. 5B, and report configuration 500-c of FIG. 5C illustrate a non-limiting example of differential quantization techniques that may be applied to the first CSI report indicating the set of measurement results and the set of predicted measurement results for the k prediction occasions.

The techniques described herein provide efficient techniques for a UE to report a set of measurement results (e.g., L1-RSRP/SINR, shown as RSRP #0-3 by way of non-limiting example) and the associated first set of beam identifiers (e.g., CMR-IDs) for the set of measurement results, along with a set of predicted measurement results for multiple prediction occasions in a first CSI report sent to a network entity. The first CSI report may also include a bit or bits, a flag, a field, and/or a parameter set to a value to indicate whether there are any differences between the first set of beam identifiers (e.g., as reported in the first CSI report) and a second set of beam identifiers (e.g., CMR-IDs) for the set of predicted measurement results, without reporting the second set of beam identifiers in the first CSI report. If there are differences, this may trigger a grant scheduling a second CSI report that identifies a mapping of the differences. That is, if “1” is reported for the additional bit in the first CSI report, this may indicate that at least one of the CMR-ID (or its relative order) is different from the corresponding CMR-ID for the first time domain occasion (e.g., the measurement occasion for the set of measurement results). Indicating the “1” in the first CSI report may trigger transmission of a grant scheduling a second report. The UE may transmit the second report according to the grant and include, in the second report, a mapping of difference(s) between the first set of beam identifiers (e.g., CMR-IDs for the measured results and indicated in the first report) and the second set of beam identifiers (e.g., CMR-IDs for the predicted results, but not indicated in the first report).

When transmitting the first report, the UE may apply different quantization techniques for the measured results and the predicted results. That is, the set of measurement results may include a measurement result 505 and a beam identifier 510 corresponding to each measurement result 505. The beam identifier 510 may include the CMR-ID (e.g., beam identifier) for the corresponding measurement result 505 (e.g., provide identifying information, such as the beam identifier, for the measurement result 505). The set of predicted measurement result may include a predicted result 515 for a first prediction occasion, a predicted result 520 for a second prediction occasion, and a predicted result 525 for a final prediction occasion (e.g., based on k). The UE may apply one or more of the quantization schemes to the measured and/or predicted results (e.g., to improve efficiency). Quantization techniques generally provide approaches to map values or numbers from a first, larger or (pre)selected individual or set of values or numbers to a second, smaller (pre)selected individual or set of values or numbers. Rounding, truncation, and similar techniques, may be applied to the second set relative to the first set may be applied to reduce the number of bits used to convey the information.

As one non-limiting example and referring first to report configuration 500-a of FIG. 5A, for each prediction/measurement occasion, the strongest L1-RSRP/L1-SINR of the N L1-RSRPs/L1-SINRs for the considered occasion, may be reported via M₁ bits (e.g., 7-bits) absolutely, while the remaining ones are reported differentially referring to the strongest one via M₂ bits (e.g., 4-bits). That is, the measured result (e.g., RSRP and/or SINR) for the measurement occasion having the strongest value (e.g., RSRP #0 in this example) may be reported using a first number of bits (e.g., seven bits). Each additional measured result for the measurement occasion having a lower value relative to RSRP #0 may be reported differentially using a second number of bits (e.g., four bits). Similarly for the reported predicted results during each prediction occasion, the predicted result having the strongest value (e.g., again RSRP #0 in this example) may be reported using the first number of bits (e.g., seven bits). Each additional predicted result for the prediction occasion having a lower value relative to RSRP #0 may be reported differentially using a second number of bits (e.g., four bits). Differential reporting may include reporting the difference between the RSRP #0 and the other RSRPs for the occasion rather than the absolute value of those other RSRPs. Reporting the difference may reduce the number of bits required to convey the measured and/or predicted results in the first report. In some examples, positive dB values may be used for the differential quantization, which may be associated with quantization table(s) applied when transmitting the first report.

Referring to report configuration 500-b of FIG. 5B, illustrated therein is another example of a quantization scheme that may be applied in the first report. Report configuration 500-b illustrates an example differential quantization framework where a certain L1-RSRP/L1-SINR in a prediction occasion, is differentially quantized referring to the L1-RSRP/L1-SINR associated with the same CMR-ID order in the first time domain measurement occasion. For the first measurement occasion, the L1-RSRPs/L1-SINRs may be all quantized absolutely using an identical number of bits (e.g., 7-bits) or the strongest one may be absolutely quantized via M₁ bits (e.g., 7-bits) absolutely, while the remaining ones are reported differentially referring to the strongest one via M₂ bits (e.g., 4-bits). That is, report configuration 500-b illustrates an example where each measured result may be absolutely quantized (e.g. the actual RSRP value is reported) in the first report or the first (e.g., strongest) RSRP (e.g., RSRP #0 in this example) may be absolutely quantized, while the remaining measured results are differentially reported relative to RSRP #0. However, each predicted result in each prediction occasion may be differentially reported relative to the corresponding measured result (e.g., predicted RSRP #0 during each prediction occasion is differentially reported relative to measured RSRP #0).

Referring to report configuration 500-c of FIG. 5C, illustrated therein is another example of a quantization scheme that may be applied in the first report. Report configuration 500-c illustrates an example differential quantization framework where a certain L1-RSRP/L1-SINR in a prediction occasion, is differentially quantized referring to the L1-RSRP/L1-SINR associated with the same CMR-ID order in the time domain measurement and prediction occasions preceding the considered prediction occasion. For the first measurement occasion, the L1-RSRPs/L1-SINRs may be all quantized absolutely using an identical number of bits (e.g., 7-bits) or he strongest one may be absolutely quantized via M₁ bits (e.g., 7-bits) absolutely, while the remaining ones are reported differentially referring to the strongest one via M₂ bits (e.g., 4-bits) That is, report configuration 500-c illustrates an example where each measured result may be absolutely quantized (e.g. the actual RSRP value is reported) in the first report or the first (e.g., strongest) RSRP (e.g., RSRP #0 in this example) may be absolutely quantized, while the remaining measured results are differentially reported relative to RSRP #0.However, each predicted result in each prediction occasion may be differentially reported relative to the preceding prediction occasion and, for the first prediction occasion, relative to the measured result. That is, the predicted result for RSRP #0 during a second prediction occasion may be reported differentially relative to the predicted result for RSRP #0 during a first prediction occasion.

In some aspects, L1-RSRP/L1-SINR quantization tables may be applied for the described quantization schemes. At least a portion (e.g., one or more entries in the tables) of the quantization tables may be applied to the set of measurement results and/or to the set of predicted measurement results in the first report. The differential quantization of the L1-RSRP/L1-SINR in the prediction occasions may be based on a newly introduced L1-RSRP/L1-SINR differential quantization table. The quantization table may include both differential dB values that are stronger or weaker than the reference L1-RSRP/L1-SINR.

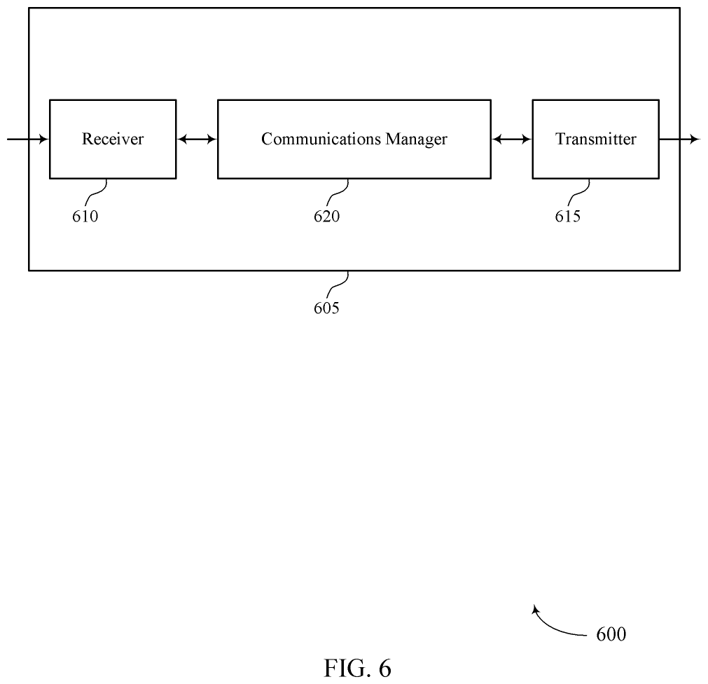

FIG. 6 illustrates a block diagram 600 of a device 605 that supports overhead reduction for feedback on beam prediction results in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to overhead reduction for feedback on beam prediction results). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to overhead reduction for feedback on beam prediction results). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of overhead reduction for feedback on beam prediction results as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware, software (e.g., executed by a processor), or any combination thereof. The hardware may include a processor, a digital signal processor (DSP), a central processing unit (CPU), a graphics processor unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software) executed by a processor. If implemented in code executed by a processor, the functions of the communications manager 620, the receiver 610, the transmitter 615, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. For example, the communications manager 620 may be configured as or otherwise support a means for transmitting a first report including a set of measurement results and a set of predicted measurement results, the first report further including an indication of one or more differences between a first set of beam identifiers associated with the set of measurement results and a second set of beam identifiers associated with the set of predicted measurement results. The communications manager 620 may be configured as or otherwise support a means for receiving, based on the indication of the one or more differences, a grant scheduling transmission of a second report. The communications manager 620 may be configured as or otherwise support a means for transmitting the second report according to the grant, the second report identifying a mapping of the one or more differences between the first set of beam identifiers and the second set of beam identifiers.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for improved CSI reporting using reduced overhead to signal differences between measured and predicted measurement results.

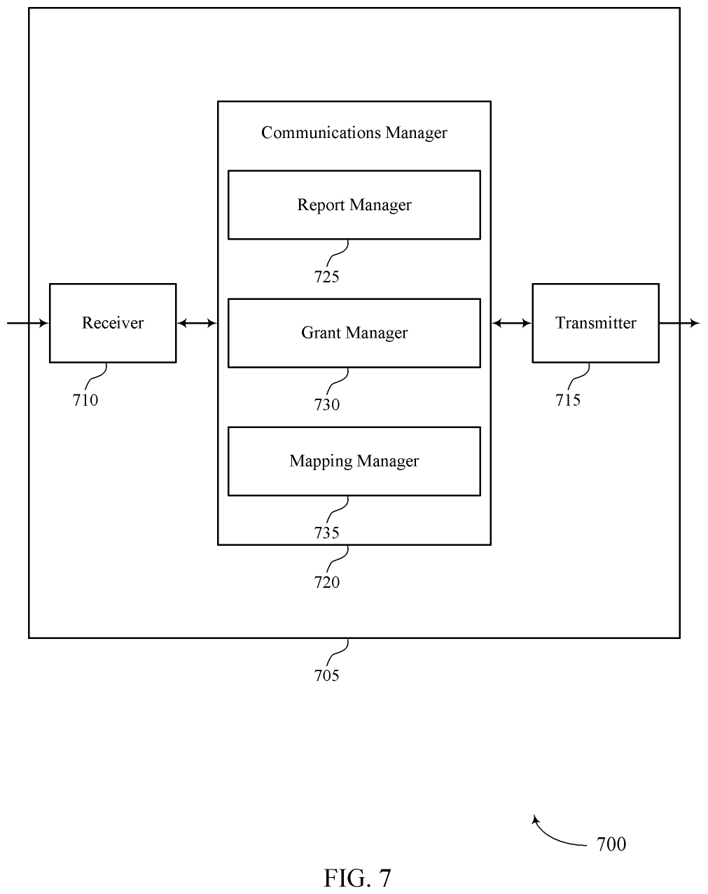

FIG. 7 illustrates a block diagram 700 of a device 705 that supports overhead reduction for feedback on beam prediction results in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to overhead reduction for feedback on beam prediction results). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to overhead reduction for feedback on beam prediction results). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of overhead reduction for feedback on beam prediction results as described herein. For example, the communications manager 720 may include a report manager 725, a grant manager 730, a mapping manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. The report manager 725 may be configured as or otherwise support a means for transmitting a first report including a set of measurement results and a set of predicted measurement results, the first report further including an indication of one or more differences between a first set of beam identifiers associated with the set of measurement results and a second set of beam identifiers associated with the set of predicted measurement results. The grant manager 730 may be configured as or otherwise support a means for receiving, based on the indication of the one or more differences, a grant scheduling transmission of a second report. The mapping manager 735 may be configured as or otherwise support a means for transmitting the second report according to the grant, the second report identifying a mapping of the one or more differences between the first set of beam identifiers and the second set of beam identifiers.

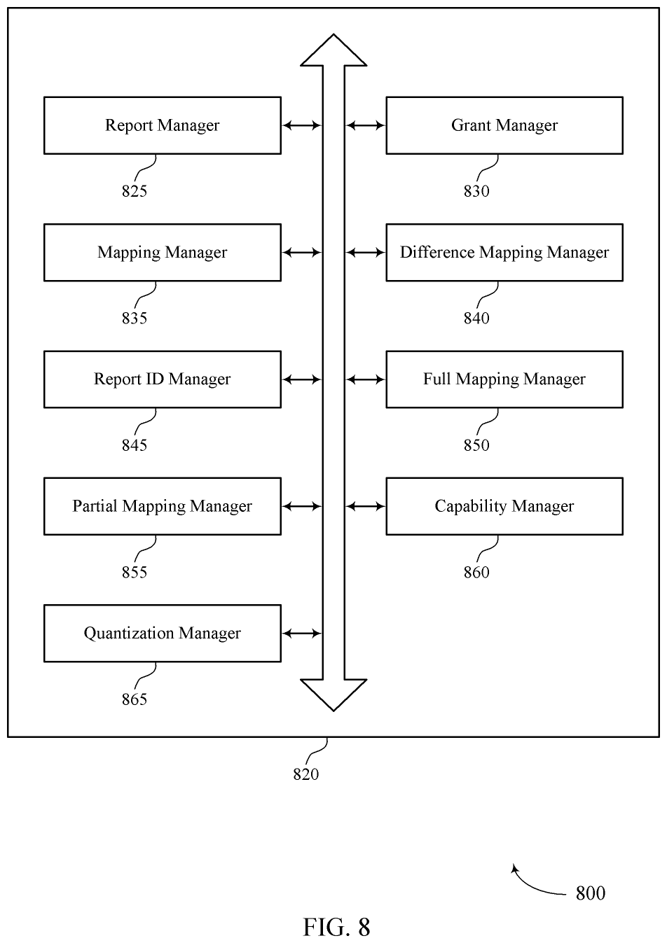

FIG. 8 illustrates a block diagram 800 of a communications manager 820 that supports overhead reduction for feedback on beam prediction results in accordance with one or more aspects of the present disclosure. The communications manager 820 may be an example of aspects of a communications manager 620, a communications manager 720, or both, as described herein. The communications manager 820, or various components thereof, may be an example of means for performing various aspects of overhead reduction for feedback on beam prediction results as described herein. For example, the communications manager 820 may include a report manager 825, a grant manager 830, a mapping manager 835, a difference mapping manager 840, a report ID manager 845, a full mapping manager 850, a partial mapping manager 855, a capability manager 860, a quantization manager 865, or any combination thereof. Each of these components may communicate, directly or indirectly, with one another (e.g., via one or more buses).

The communications manager 820 may support wireless communication at a UE in accordance with examples as disclosed herein. The report manager 825 may be configured as or otherwise support a means for transmitting a first report including a set of measurement results and a set of predicted measurement results, the first report further including an indication of one or more differences between a first set of beam identifiers associated with the set of measurement results and a second set of beam identifiers associated with the set of predicted measurement results. The grant manager 830 may be configured as or otherwise support a means for receiving, based on the indication of the one or more differences, a grant scheduling transmission of a second report. The mapping manager 835 may be configured as or otherwise support a means for transmitting the second report according to the grant, the second report identifying a mapping of the one or more differences between the first set of beam identifiers and the second set of beam identifiers.

In some examples, the difference mapping manager 840 may be configured as or otherwise support a means for performing a set of channel performance measurements to obtain the set of measurement results for the first set of beam identifiers. In some examples, the difference mapping manager 840 may be configured as or otherwise support a means for determining a set of predicted channel performance measurements to obtain the set of measurement results for the second set of beam identifiers. In some examples, the difference mapping manager 840 may be configured as or otherwise support a means for identifying the one or more differences between the first set of beam identifiers and the second set of beam identifiers, where a bit or flag in the first report is set to a value to indicate that the one or more differences have been identified.

In some examples, the difference mapping manager 840 may be configured as or otherwise support a means for determining that one or more beam identifiers in the second set of beam identifiers are different from beam identifiers in the first set of beam identifiers, where the one or more differences is based on the difference of the one or more beam identifiers. In some examples, the difference mapping manager 840 may be configured as or otherwise support a means for determining that beam identifiers in the second set of beam identifiers are in a different order in the first set of beam identifiers, where the one or more differences is based on the different order. In some examples, the first report indicates the first set of beam identifiers without indicating the second set of beam identifiers.

In some examples, the report ID manager 845 may be configured as or otherwise support a means for identifying a report identifier associated with the first report. In some examples, the report ID manager 845 may be configured as or otherwise support a means for including the report identifier in the second report based on the one or more differences, where the second report includes a dynamically triggered CSI report.

In some examples, the report ID manager 845 may be configured as or otherwise support a means for identifying a report identifier associated with the second report. In some examples, the report ID manager 845 may be configured as or otherwise support a means for including the report identifier in the first report based on the one or more differences, where the second report includes a dynamically triggered CSI report.

In some examples, the full mapping manager 850 may be configured as or otherwise support a means for identifying each beam identifier in the second set of beam identifiers. In some examples, the full mapping manager 850 may be configured as or otherwise support a means for including an indication of each beam identifier in the second report based on the one or more differences, where the second report includes a MAC-CE report.

In some examples, the partial mapping manager 855 may be configured as or otherwise support a means for identifying each difference between the first set of beam identifiers and the second set of beam identifiers. In some examples, the partial mapping manager 855 may be configured as or otherwise support a means for including an indication of each difference in the second report based on the one or more differences, where the second report includes a MAC-CE report.

In some examples, the report ID manager 845 may be configured as or otherwise support a means for identifying a report identifier of the first report and a transmission slot of the first report. In some examples, the report ID manager 845 may be configured as or otherwise support a means for including an indication of the report identifier, the transmission slot, or both, in the second report.

In some examples, the capability manager 860 may be configured as or otherwise support a means for transmitting a UE capability message indicating a support for indicating the one or more differences. In some examples, the capability manager 860 may be configured as or otherwise support a means for receiving, from a network entity, a signal indicating a support for indicating the one or more differences.

In some examples, the quantization manager 865 may be configured as or otherwise support a means for applying one or more quantization schemes to the set of measurement results, to a set of beam identifiers associated with the set of measurement results, or both, in the first report. In some examples, the quantization manager 865 may be configured as or otherwise support a means for identifying a quantization table associated with reporting the one or more differences. In some examples, the quantization manager 865 may be configured as or otherwise support a means for applying at least a portion of the quantization table to the set of measurement results, to a set of beam identifiers associated with the set of measurement results, or both, in the first report.

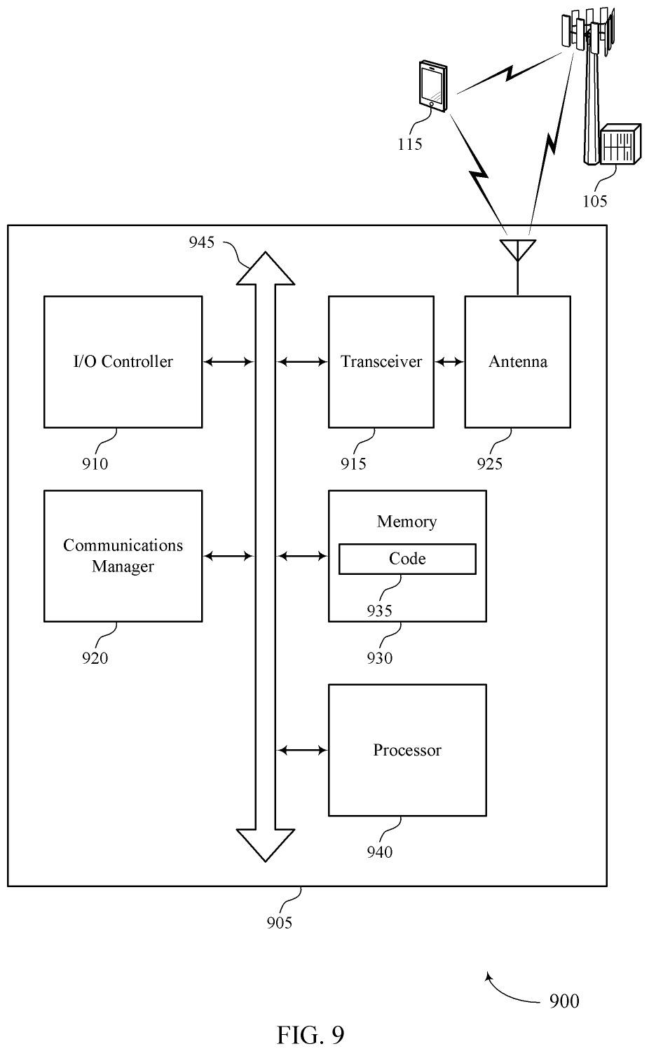

FIG. 9 illustrates a diagram of a system 900 including a device 905 that supports overhead reduction for feedback on beam prediction results in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting overhead reduction for feedback on beam prediction results). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for transmitting a first report including a set of measurement results and a set of predicted measurement results, the first report further including an indication of one or more differences between a first set of beam identifiers associated with the set of measurement results and a second set of beam identifiers associated with the set of predicted measurement results. The communications manager 920 may be configured as or otherwise support a means for receiving, based on the indication of the one or more differences, a grant scheduling transmission of a second report. The communications manager 920 may be configured as or otherwise support a means for transmitting the second report according to the grant, the second report identifying a mapping of the one or more differences between the first set of beam identifiers and the second set of beam identifiers.

By including or configuring the communications manager 920 in accordance with examples as described herein, the device 905 may support techniques for improved CSI reporting using reduced overhead to signal differences between measured and predicted measurement results.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of overhead reduction for feedback on beam prediction results as described herein, or the processor 940 and the memory 930 may be otherwise configured to perform or support such operations.

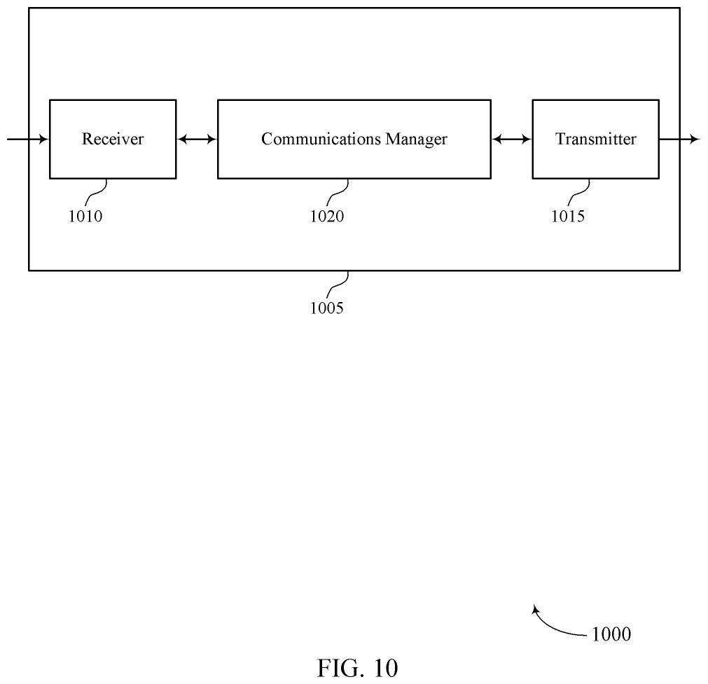

FIG. 10 illustrates a block diagram 1000 of a device 1005 that supports overhead reduction for feedback on beam prediction results in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of overhead reduction for feedback on beam prediction results as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware, software (e.g., executable by a processor), or any combination thereof. The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software) executed by a processor. If implemented in code executed by a processor, the functions of the communications manager 1020, the receiver 1010, the transmitter 1015, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. For example, the communications manager 1020 may be configured as or otherwise support a means for receiving a first report including a set of measurement results and a set of predicted measurement results, the first report further including an indication of one or more differences between a first set of beam identifiers associated with the set of measurement results and a second set of beam identifiers associated with the set of predicted measurement results. The communications manager 1020 may be configured as or otherwise support a means for transmitting, based on the indication of the one or more differences, a grant scheduling transmission of a second report. The communications manager 1020 may be configured as or otherwise support a means for receiving the second report according to the grant, the second report identifying a mapping of the one or more differences between the first set of beam identifiers and the second set of beam identifiers.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for improved CSI reporting using reduced overhead to signal differences between measured and predicted measurement results.

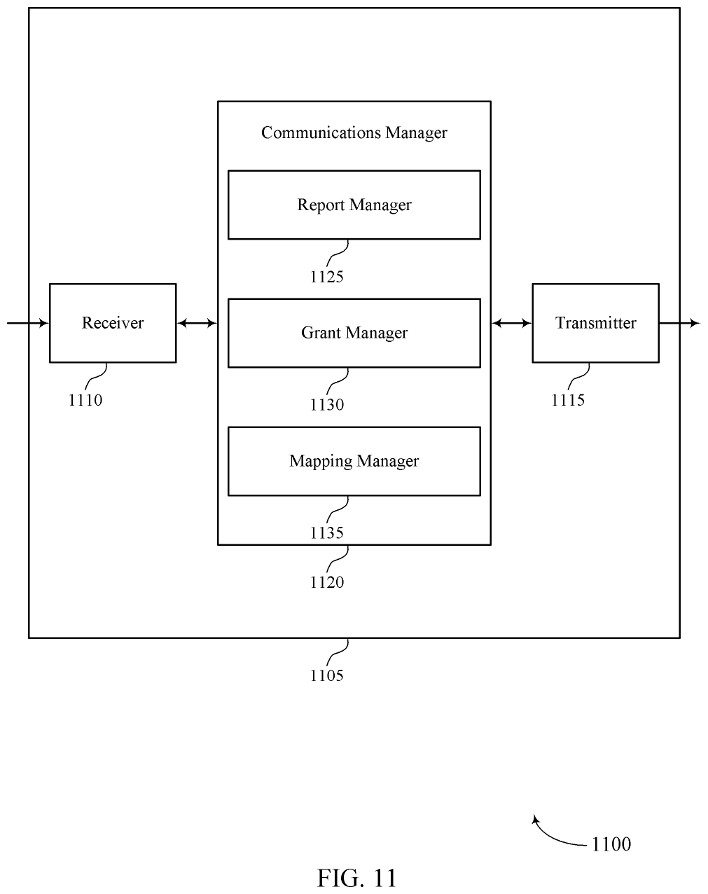

FIG. 11 illustrates a block diagram 1100 of a device 1105 that supports overhead reduction for feedback on beam prediction results in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of overhead reduction for feedback on beam prediction results as described herein. For example, the communications manager 1120 may include a report manager 1125, a grant manager 1130, a mapping manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. The report manager 1125 may be configured as or otherwise support a means for receiving a first report including a set of measurement results and a set of predicted measurement results, the first report further including an indication of one or more differences between a first set of beam identifiers associated with the set of measurement results and a second set of beam identifiers associated with the set of predicted measurement results. The grant manager 1130 may be configured as or otherwise support a means for transmitting, based on the indication of the one or more differences, a grant scheduling transmission of a second report. The mapping manager 1135 may be configured as or otherwise support a means for receiving the second report according to the grant, the second report identifying a mapping of the one or more differences between the first set of beam identifiers and the second set of beam identifiers.

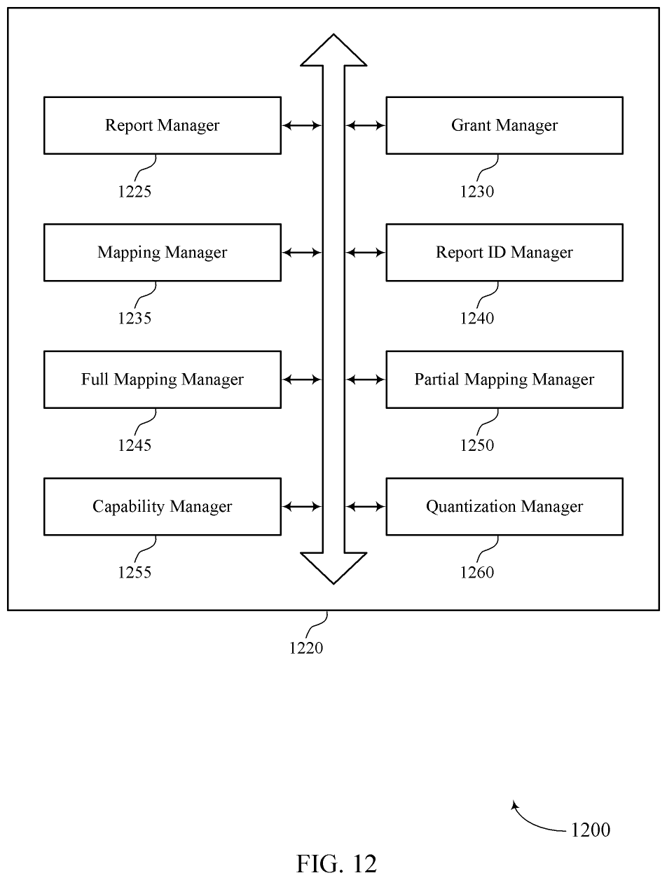

FIG. 12 illustrates a block diagram 1200 of a communications manager 1220 that supports overhead reduction for feedback on beam prediction results in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of overhead reduction for feedback on beam prediction results as described herein. For example, the communications manager 1220 may include a report manager 1225, a grant manager 1230, a mapping manager 1235, a report ID manager 1240, a full mapping manager 1245, a partial mapping manager 1250, a capability manager 1255, a quantization manager 1260, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a network entity in accordance with examples as disclosed herein. The report manager 1225 may be configured as or otherwise support a means for receiving a first report including a set of measurement results and a set of predicted measurement results, the first report further including an indication of one or more differences between a first set of beam identifiers associated with the set of measurement results and a second set of beam identifiers associated with the set of predicted measurement results. The grant manager 1230 may be configured as or otherwise support a means for transmitting, based on the indication of the one or more differences, a grant scheduling transmission of a second report. The mapping manager 1235 may be configured as or otherwise support a means for receiving the second report according to the grant, the second report identifying a mapping of the one or more differences between the first set of beam identifiers and the second set of beam identifiers.

In some examples, the report ID manager 1240 may be configured as or otherwise support a means for determining, based on the indication of the one or more differences, that one or more beam identifiers in the second set of beam identifiers are different from beam identifiers in the first set of beam identifiers, where the one or more differences is based on the difference of the one or more beam identifiers.

In some examples, the report ID manager 1240 may be configured as or otherwise support a means for determining, based on the indication of the one or more differences, that beam identifiers in the second set of beam identifiers are in a different order in the first set of beam identifiers, where the one or more differences is based on the different order. In some examples, the first report indicates the first set of beam identifiers without indicating the second set of beam identifiers.

In some examples, the report ID manager 1240 may be configured as or otherwise support a means for determining that a report identifier associated with the first report is included in the second report based on the one or more differences, where the second report includes a dynamically triggered CSI report. In some examples, the report ID manager 1240 may be configured as or otherwise support a means for determining that a report identifier associated with the second report is included in the second report based on the one or more differences, where the second report includes a dynamically triggered CSI report.

In some examples, the full mapping manager 1245 may be configured as or otherwise support a means for determining that an indication of each beam identifier in the second set of beam identifiers is included in the second report based on the one or more differences, where the second report includes a MAC-CE report.

In some examples, the partial mapping manager 1250 may be configured as or otherwise support a means for determining that an indication of each difference between the first set of beam identifiers and the second set of beam identifiers is included in the second report based on the one or more differences, where the second report includes a MAC-CE report.

In some examples, the report ID manager 1240 may be configured as or otherwise support a means for identifying, based on the second report, a report identifier of the first report, a transmission slot of the first report, or both.

In some examples, the capability manager 1255 may be configured as or otherwise support a means for receiving a UE capability message indicating a support for indicating the one or more differences. In some examples, the capability manager 1255 may be configured as or otherwise support a means for transmitting a signal indicating a support for indicating the one or more differences.

In some examples, the quantization manager 1260 may be configured as or otherwise support a means for applying one or more quantization schemes to the set of measurement results, to a set of beam identifiers associated with the set of measurement results, or both, indicated in the first report.

In some examples, the quantization manager 1260 may be configured as or otherwise support a means for identifying a quantization table associated with reporting the one or more differences. In some examples, the quantization manager 1260 may be configured as or otherwise support a means for applying at least a portion of the quantization table to the set of measurement results, to a set of beam identifiers associated with the set of measurement results, or both, indicated in the first report.

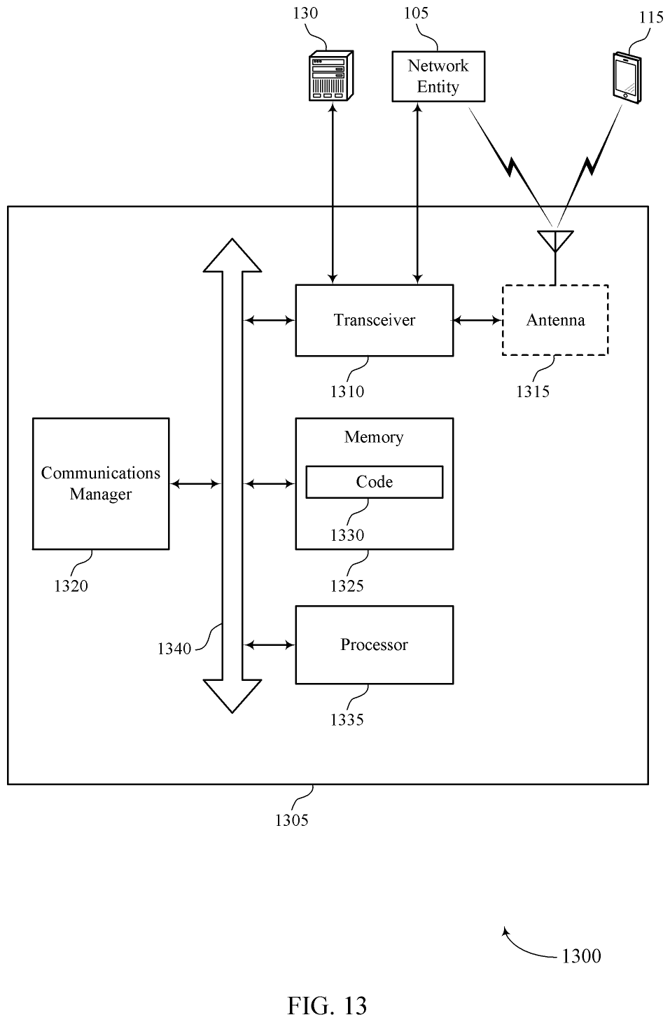

FIG. 13 illustrates a diagram of a system 1300 including a device 1305 that supports overhead reduction for feedback on beam prediction results in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting overhead reduction for feedback on beam prediction results). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a network entity in accordance with examples as disclosed herein. For example, the communications manager 1320 may be configured as or otherwise support a means for receiving a first report including a set of measurement results and a set of predicted measurement results, the first report further including an indication of one or more differences between a first set of beam identifiers associated with the set of measurement results and a second set of beam identifiers associated with the set of predicted measurement results. The communications manager 1320 may be configured as or otherwise support a means for transmitting, based on the indication of the one or more differences, a grant scheduling transmission of a second report. The communications manager 1320 may be configured as or otherwise support a means for receiving the second report according to the grant, the second report identifying a mapping of the one or more differences between the first set of beam identifiers and the second set of beam identifiers.

By including or configuring the communications manager 1320 in accordance with examples as described herein, the device 1305 may support techniques for improved CSI reporting using reduced overhead to signal differences between measured and predicted measurement results.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of overhead reduction for feedback on beam prediction results as described herein, or the processor 1335 and the memory 1325 may be otherwise configured to perform or support such operations.

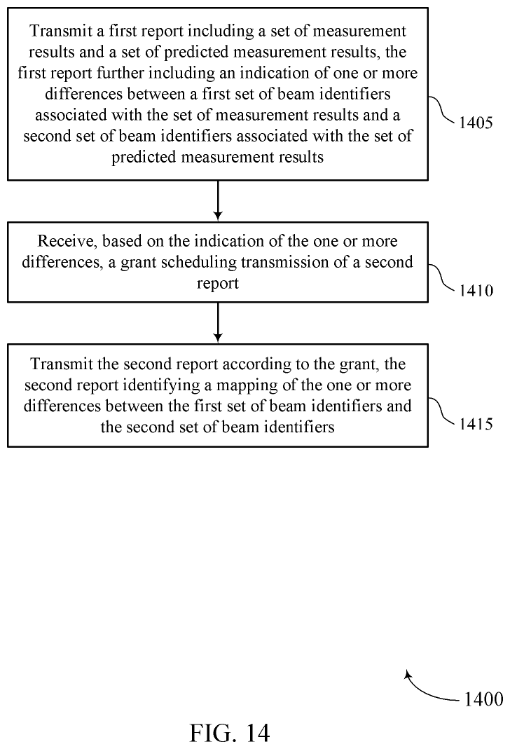

FIG. 14 illustrates a flowchart illustrating a method 1400 that supports overhead reduction for feedback on beam prediction results in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include transmitting a first report including a set of measurement results and a set of predicted measurement results, the first report further including an indication of one or more differences between a first set of beam identifiers associated with the set of measurement results and a second set of beam identifiers associated with the set of predicted measurement results. The operations of 1405 may be performed in accordance with examples as disclosed herein. In some examples, aspects of the operations of 1405 may be performed by a report manager 825 as described with reference to FIG. 8.

At 1410, the method may include receiving, based on the indication of the one or more differences, a grant scheduling transmission of a second report. The operations of 1410 may be performed in accordance with examples as disclosed herein. In some examples, aspects of the operations of 1410 may be performed by a grant manager 830 as described with reference to FIG. 8.

At 1415, the method may include transmitting the second report according to the grant, the second report identifying a mapping of the one or more differences between the first set of beam identifiers and the second set of beam identifiers. The operations of 1415 may be performed in accordance with examples as disclosed herein. In some examples, aspects of the operations of 1415 may be performed by a mapping manager 835 as described with reference to FIG. 8.

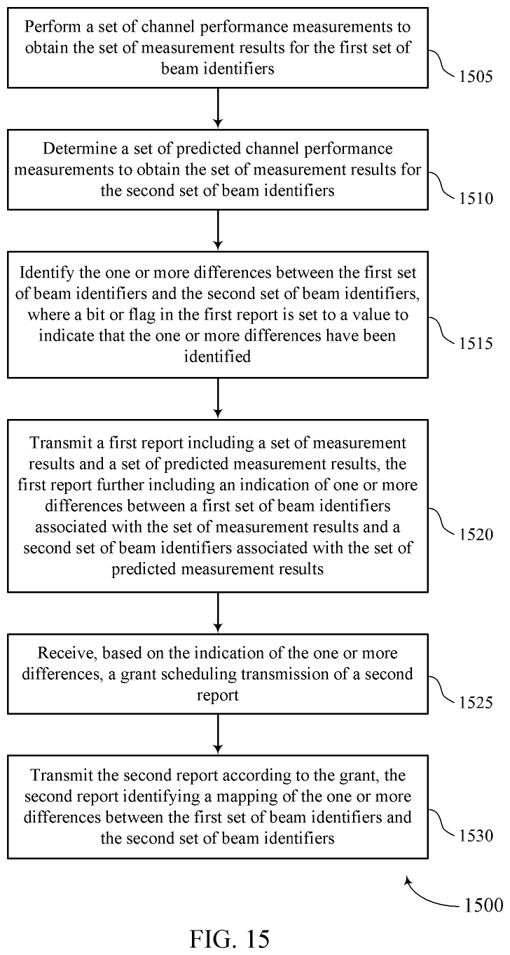

FIG. 15 illustrates a flowchart illustrating a method 1500 that supports overhead reduction for feedback on beam prediction results in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include performing a set of channel performance measurements to obtain the set of measurement results for the first set of beam identifiers. The operations of 1505 may be performed in accordance with examples as disclosed herein. In some examples, aspects of the operations of 1505 may be performed by a difference mapping manager 840 as described with reference to FIG. 8.

At 1510, the method may include determining a set of predicted channel performance measurements to obtain the set of measurement results for the second set of beam identifiers. The operations of 1510 may be performed in accordance with examples as disclosed herein. In some examples, aspects of the operations of 1510 may be performed by a difference mapping manager 840 as described with reference to FIG. 8.

At 1515, the method may include identifying the one or more differences between the first set of beam identifiers and the second set of beam identifiers, where a bit or flag in the first report is set to a value to indicate that the one or more differences have been identified. The operations of 1515 may be performed in accordance with examples as disclosed herein. In some examples, aspects of the operations of 1515 may be performed by a difference mapping manager 840 as described with reference to FIG. 8.

At 1520, the method may include transmitting a first report including a set of measurement results and a set of predicted measurement results, the first report further including an indication of one or more differences between a first set of beam identifiers associated with the set of measurement results and a second set of beam identifiers associated with the set of predicted measurement results. The operations of 1520 may be performed in accordance with examples as disclosed herein. In some examples, aspects of the operations of 1520 may be performed by a report manager 825 as described with reference to FIG. 8.

At 1525, the method may include receiving, based on the indication of the one or more differences, a grant scheduling transmission of a second report. The operations of 1525 may be performed in accordance with examples as disclosed herein. In some examples, aspects of the operations of 1525 may be performed by a grant manager 830 as described with reference to FIG. 8.

At 1530, the method may include transmitting the second report according to the grant, the second report identifying a mapping of the one or more differences between the first set of beam identifiers and the second set of beam identifiers. The operations of 1530 may be performed in accordance with examples as disclosed herein. In some examples, aspects of the operations of 1530 may be performed by a mapping manager 835 as described with reference to FIG. 8.

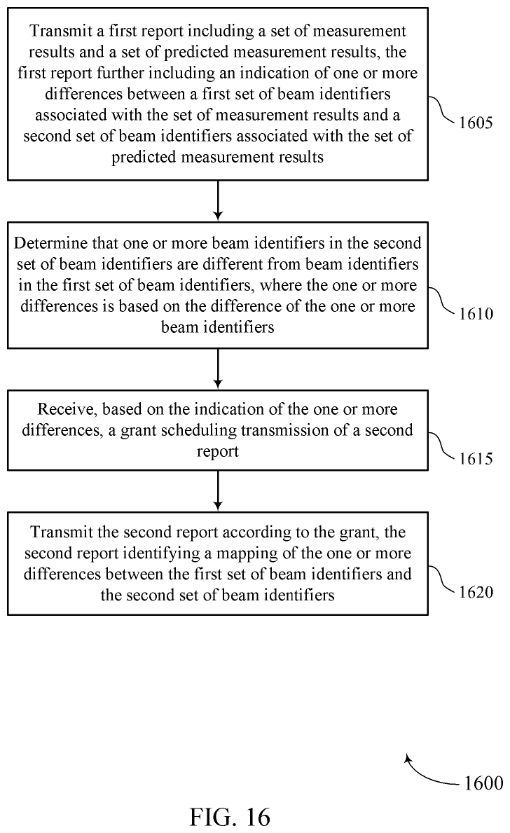

FIG. 16 illustrates a flowchart illustrating a method 1600 that supports overhead reduction for feedback on beam prediction results in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include transmitting a first report including a set of measurement results and a set of predicted measurement results, the first report further including an indication of one or more differences between a first set of beam identifiers associated with the set of measurement results and a second set of beam identifiers associated with the set of predicted measurement results. The operations of 1605 may be performed in accordance with examples as disclosed herein. In some examples, aspects of the operations of 1605 may be performed by a report manager 825 as described with reference to FIG. 8.

At 1610, the method may include determining that one or more beam identifiers in the second set of beam identifiers are different from beam identifiers in the first set of beam identifiers, where the one or more differences is based on the difference of the one or more beam identifiers. The operations of 1610 may be performed in accordance with examples as disclosed herein. In some examples, aspects of the operations of 1610 may be performed by a difference mapping manager 840 as described with reference to FIG. 8.

At 1615, the method may include receiving, based on the indication of the one or more differences, a grant scheduling transmission of a second report. The operations of 1615 may be performed in accordance with examples as disclosed herein. In some examples, aspects of the operations of 1615 may be performed by a grant manager 830 as described with reference to FIG. 8.

At 1620, the method may include transmitting the second report according to the grant, the second report identifying a mapping of the one or more differences between the first set of beam identifiers and the second set of beam identifiers. The operations of 1620 may be performed in accordance with examples as disclosed herein. In some examples, aspects of the operations of 1620 may be performed by a mapping manager 835 as described with reference to FIG. 8.

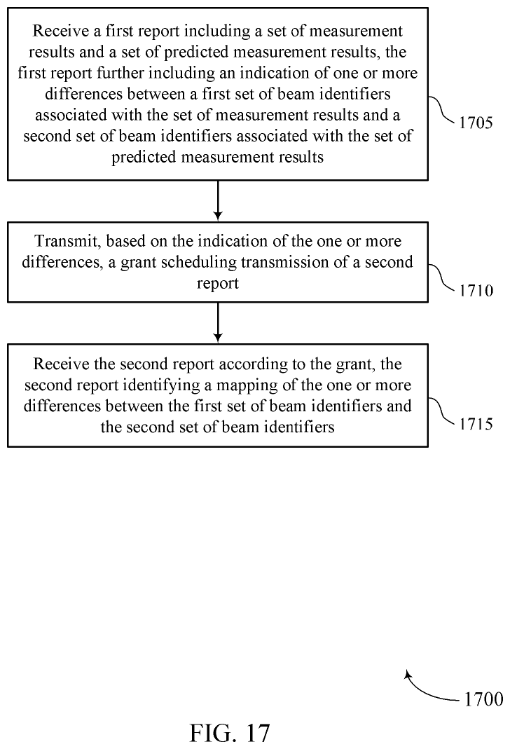

FIG. 17 illustrates a flowchart illustrating a method 1700 that supports overhead reduction for feedback on beam prediction results in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include receiving a first report including a set of measurement results and a set of predicted measurement results, the first report further including an indication of one or more differences between a first set of beam identifiers associated with the set of measurement results and a second set of beam identifiers associated with the set of predicted measurement results. The operations of 1705 may be performed in accordance with examples as disclosed herein. In some examples, aspects of the operations of 1705 may be performed by a report manager 1225 as described with reference to FIG. 12.

At 1710, the method may include transmitting, based on the indication of the one or more differences, a grant scheduling transmission of a second report. The operations of 1710 may be performed in accordance with examples as disclosed herein. In some examples, aspects of the operations of 1710 may be performed by a grant manager 1230 as described with reference to FIG. 12.

At 1715, the method may include receiving the second report according to the grant, the second report identifying a mapping of the one or more differences between the first set of beam identifiers and the second set of beam identifiers. The operations of 1715 may be performed in accordance with examples as disclosed herein. In some examples, aspects of the operations of 1715 may be performed by a mapping manager 1235 as described with reference to FIG. 12.

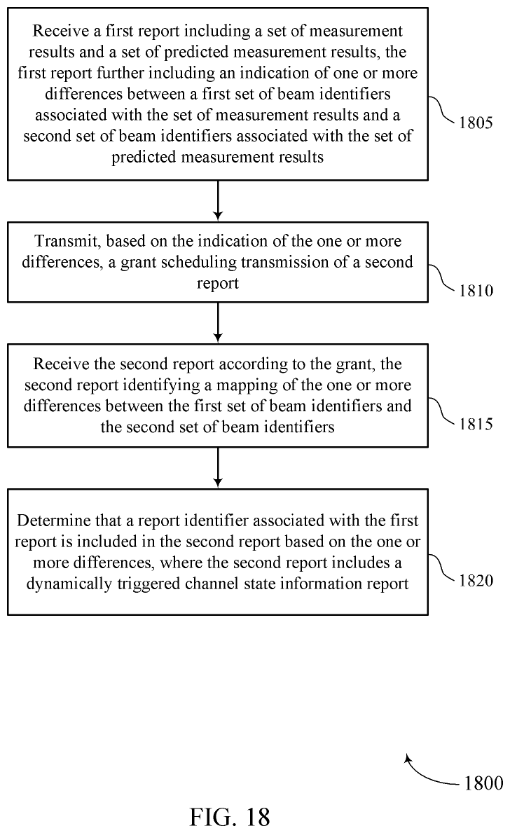

FIG. 18 illustrates a flowchart illustrating a method 1800 that supports overhead reduction for feedback on beam prediction results in accordance with one or more aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include receiving a first report including a set of measurement results and a set of predicted measurement results, the first report further including an indication of one or more differences between a first set of beam identifiers associated with the set of measurement results and a second set of beam identifiers associated with the set of predicted measurement results. The operations of 1805 may be performed in accordance with examples as disclosed herein. In some examples, aspects of the operations of 1805 may be performed by a report manager 1225 as described with reference to FIG. 12.

At 1810, the method may include transmitting, based on the indication of the one or more differences, a grant scheduling transmission of a second report. The operations of 1810 may be performed in accordance with examples as disclosed herein. In some examples, aspects of the operations of 1810 may be performed by a grant manager 1230 as described with reference to FIG. 12.

At 1815, the method may include receiving the second report according to the grant, the second report identifying a mapping of the one or more differences between the first set of beam identifiers and the second set of beam identifiers. The operations of 1815 may be performed in accordance with examples as disclosed herein. In some examples, aspects of the operations of 1815 may be performed by a mapping manager 1235 as described with reference to FIG. 12.

At 1820, the method may include determining that a report identifier associated with the first report is included in the second report based on the one or more differences, where the second report includes a dynamically triggered channel state information report. The operations of 1820 may be performed in accordance with examples as disclosed herein. In some examples, aspects of the operations of 1820 may be performed by a report ID manager 1240 as described with reference to FIG. 12.

The following provides an overview of aspects of the present disclosure:
Aspect 1: A method for wireless communication at a UE, comprising: transmitting a first report including a set of measurement results and a set of predicted measurement results, the first report further including an indication of one or more differences between a first set of beam identifiers associated with the set of measurement results and a second set of beam identifiers associated with the set of predicted measurement results; receiving, based at least in part on the indication of the one or more differences, a grant scheduling transmission of a second report; and transmitting the second report according to the grant, the second report identifying a mapping of the one or more differences between the first set of beam identifiers and the second set of beam identifiers.
Aspect 2: The method of aspect 1, further comprising: performing a set of channel performance measurements to obtain the set of measurement results for the first set of beam identifiers; determining a set of predicted channel performance measurements to obtain the set of measurement results for the second set of beam identifiers; and identifying the one or more differences between the first set of beam identifiers and the second set of beam identifiers, wherein a bit or flag in the first report is set to a value to indicate that the one or more differences have been identified.
Aspect 3: The method of any of aspects 1 through 2, further comprising: determining that one or more beam identifiers in the second set of beam identifiers are different from beam identifiers in the first set of beam identifiers, wherein the one or more differences is based at least in part on the difference of the one or more beam identifiers.
Aspect 4: The method of any of aspects 1 through 3, further comprising: determining that beam identifiers in the second set of beam identifiers are in a different order in the first set of beam identifiers, wherein the one or more differences is based at least in part on the different order.
Aspect 5: The method of any of aspects 1 through 4, wherein the first report indicates the first set of beam identifiers without indicating the second set of beam identifiers.
Aspect 6: The method of any of aspects 1 through 5, further comprising: identifying a report identifier associated with the first report; and including the report identifier in the second report based at least in part on the one or more differences, wherein the second report comprises a dynamically triggered CSI report.
Aspect 7: The method of any of aspects 1 through 6, further comprising: identifying a report identifier associated with the second report; and including the report identifier in the first report based at least in part on the one or more differences, wherein the second report comprises a dynamically triggered CSI report.
Aspect 8: The method of any of aspects 1 through 7, further comprising: identifying each beam identifier in the second set of beam identifiers; and including an indication of each beam identifier in the second report based at least in part on the one or more differences, wherein the second report comprises a MAC-CE report.
Aspect 9: The method of any of aspects 1 through 8, further comprising: identifying each difference between the first set of beam identifiers and the second set of beam identifiers; and including an indication of each difference in the second report based at least in part on the one or more differences, wherein the second report comprises a MAC-CE report.
Aspect 10: The method of any of aspects 1 through 9, further comprising: identifying a report identifier of the first report and a transmission slot of the first report; and including an indication of the report identifier, the transmission slot, or both, in the second report.
Aspect 11: The method of any of aspects 1 through 10, further comprising: transmitting a UE capability message indicating a support for indicating the one or more differences.
Aspect 12: The method of any of aspects 1 through 11, further comprising: receiving, from a network entity, a signal indicating a support for indicating the one or more differences.
Aspect 13: The method of any of aspects 1 through 12, further comprising: applying one or more quantization schemes to the set of measurement results, to a set of beam identifiers associated with the set of measurement results, or both, in the first report.
Aspect 14: The method of any of aspects 1 through 13, further comprising: identifying a quantization table associated with reporting the one or more differences; and applying at least a portion of the quantization table to the set of measurement results, to a set of beam identifiers associated with the set of measurement results, or both, in the first report.
Aspect 15: A method for wireless communication at a network entity, comprising: receiving a first report including a set of measurement results and a set of predicted measurement results, the first report further including an indication of one or more differences between a first set of beam identifiers associated with the set of measurement results and a second set of beam identifiers associated with the set of predicted measurement results; transmitting, based at least in part on the indication of the one or more differences, a grant scheduling transmission of a second report; and receiving the second report according to the grant, the second report identifying a mapping of the one or more differences between the first set of beam identifiers and the second set of beam identifiers.
Aspect 16: The method of aspect 15, further comprising: determining, based at least in part on the indication of the one or more differences, that one or more beam identifiers in the second set of beam identifiers are different from beam identifiers in the first set of beam identifiers, wherein the one or more differences is based at least in part on the difference of the one or more beam identifiers.
Aspect 17: The method of any of aspects 15 through 16, further comprising: determining, based at least in part on the indication of the one or more differences, that beam identifiers in the second set of beam identifiers are in a different order in the first set of beam identifiers, wherein the one or more differences is based at least in part on the different order.
Aspect 18: The method of any of aspects 15 through 17, wherein the first report indicates the first set of beam identifiers without indicating the second set of beam identifiers.
Aspect 19: The method of any of aspects 15 through 18, further comprising: determining that a report identifier associated with the first report is included in the second report based at least in part on the one or more differences, wherein the second report comprises a dynamically triggered CSI report.
Aspect 20: The method of any of aspects 15 through 19, further comprising: determining that a report identifier associated with the second report is included in the second report based at least in part on the one or more differences, wherein the second report comprises a dynamically triggered CSI report.
Aspect 21: The method of any of aspects 15 through 20, further comprising: determining that an indication of each beam identifier in the second set of beam identifiers is included in the second report based at least in part on the one or more differences, wherein the second report comprises a MAC-CE report.
Aspect 22: The method of any of aspects 15 through 21, further comprising: determining that an indication of each difference between the first set of beam identifiers and the second set of beam identifiers is included in the second report based at least in part on the one or more differences, wherein the second report comprises a MAC-CE report.
Aspect 23: The method of any of aspects 15 through 22, further comprising: identifying, based at least in part on the second report, a report identifier of the first report, a transmission slot of the first report, or both.
Aspect 24: The method of any of aspects 15 through 23, further comprising: receiving a UE capability message indicating a support for indicating the one or more differences.
Aspect 25: The method of any of aspects 15 through 24, further comprising: transmitting a signal indicating a support for indicating the one or more differences.
Aspect 26: The method of any of aspects 15 through 25, further comprising: applying one or more quantization schemes to the set of measurement results, to a set of beam identifiers associated with the set of measurement results, or both, indicated in the first report.
Aspect 27: The method of any of aspects 15 through 26, further comprising: identifying a quantization table associated with reporting the one or more differences; and applying at least a portion of the quantization table to the set of measurement results, to a set of beam identifiers associated with the set of measurement results, or both, indicated in the first report.
Aspect 28: An apparatus for wireless communication at a UE, comprising at least one processor; and memory coupled with the at least one processor, the memory storing instructions executable by the at least one processor to cause the UE to perform a method of any of aspects 1 through 14.
Aspect 29: An apparatus for wireless communication at a UE, comprising at least one means for performing a method of any of aspects 1 through 14.
Aspect 30: A non-transitory computer-readable medium storing code for wireless communications, the code comprising instructions executable by at least one processor to perform a method of any of aspects 1 through 14.
Aspect 31: An apparatus for wireless communication at a network entity, comprising at least on processor; and memory coupled with the at least one processor, the memory storing instructions executable by the at least one processor to cause the network entity to perform a method of any of aspects 15 through 27.
Aspect 32: An apparatus for wireless communication at a network entity, comprising at least one means for performing a method of any of aspects 15 through 27.
Aspect 33: A non-transitory computer-readable medium storing code for wireless communications, the code comprising instructions executable by at least one processor to perform a method of any of aspects 15 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein. Components within a wireless communication system may be coupled (for example, operatively, communicatively, functionally, electronically, and/or electrically) to each other.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a variety of actions and, therefore, “determining” can include calculating, computing, processing, deriving, investigating, looking up (such as via looking up in a table, a database or another data structure), or ascertaining. Also, “determining” can include receiving (e.g., receiving information), or accessing (e.g., accessing data stored in memory). Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a user equipment (UE), comprising:
at least one processor; and
memory coupled with the at least one processor, the memory storing instructions executable by the at least one processor to cause the UE to:
transmit a first report including a set of measurement results and a set of predicted measurement results, the first report further including an indication of one or more differences between a first set of beam identifiers associated with the set of measurement results and a second set of beam identifiers associated with the set of predicted measurement results;
receive, based at least in part on the indication of the one or more differences, a grant scheduling transmission of a second report; and
transmit the second report according to the grant, the second report identifying a mapping of the one or more differences between the first set of beam identifiers and the second set of beam identifiers.

2. The apparatus of claim 1, wherein the instructions are further executable by the at least one processor to cause the UE to:
perform a set of channel performance measurements to obtain the set of measurement results for the first set of beam identifiers;
determine a set of predicted channel performance measurements to obtain the set of measurement results for the second set of beam identifiers; and
identify the one or more differences between the first set of beam identifiers and the second set of beam identifiers, wherein a bit or flag in the first report is set to a value to indicate that the one or more differences have been identified.

3. The apparatus of claim 1, wherein the instructions are further executable by the at least one processor to cause the UE to:
determine that one or more beam identifiers in the second set of beam identifiers are different from beam identifiers in the first set of beam identifiers, wherein the one or more differences is based at least in part on the difference of the one or more beam identifiers.

4. The apparatus of claim 1, wherein the instructions are further executable by the at least one processor to cause the UE to:
determine that beam identifiers in the second set of beam identifiers are in a different order in the first set of beam identifiers, wherein the one or more differences is based at least in part on the different order.

5. The apparatus of claim 1, wherein the first report indicates the first set of beam identifiers without indicating the second set of beam identifiers.

6. The apparatus of claim 1, wherein the instructions are further executable by the at least one processor to cause the UE to:
identify a report identifier associated with the first report; and
include the report identifier in the second report based at least in part on the one or more differences, wherein the second report comprises a dynamically triggered channel state information report.

7. The apparatus of claim 1, wherein the instructions are further executable by the at least one processor to cause the UE to:
identify a report identifier associated with the second report; and
include the report identifier in the first report based at least in part on the one or more differences, wherein the second report comprises a dynamically triggered channel state information report.

8. The apparatus of claim 1, wherein the instructions are further executable by the at least one processor to cause the UE to:
identify each beam identifier in the second set of beam identifiers; and
include an indication of each beam identifier in the second report based at least in part on the one or more differences, wherein the second report comprises a medium access control-control element (MAC-CE) report.

9. The apparatus of claim 1, wherein the instructions are further executable by the at least one processor to cause the UE to:
identify each difference between the first set of beam identifiers and the second set of beam identifiers; and
include an indication of each difference in the second report based at least in part on the one or more differences, wherein the second report comprises a medium access control-control element (MAC-CE) report.

10. The apparatus of claim 1, wherein the instructions are further executable by the at least one processor to cause the UE to:
identify a report identifier of the first report and a transmission slot of the first report; and include an indication of the report identifier, the transmission slot, or both, in the second report.

11. The apparatus of claim 1, wherein the instructions are further executable by the at least one processor to cause the UE to:
transmit a UE capability message indicating a support for indicating the one or more differences.

12. The apparatus of claim 1, wherein the instructions are further executable by the at least one processor to cause the UE to:
receive, from a network entity, a signal indicating a support for indicating the one or more differences.

13. The apparatus of claim 1, wherein the instructions are further executable by the at least one processor to cause the UE to:
apply one or more quantization schemes to the set of measurement results, to a set of beam identifiers associated with the set of measurement results, or both, in the first report.

14. The apparatus of claim 1, wherein the instructions are further executable by the at least one processor to cause the UE to:
identify a quantization table associated with reporting the one or more differences; and
apply at least a portion of the quantization table to the set of measurement results, to a set of beam identifiers associated with the set of measurement results, or both, in the first report.

15. An apparatus for wireless communication at a network entity, comprising: at least one processor; and
memory coupled with the at least one processor, the memory storing instructions executable by the at least one processor to cause the network entity to:
receive a first report including a set of measurement results and a set of predicted measurement results, the first report further including an indication of one or more differences between a first set of beam identifiers associated with the set of measurement results and a second set of beam identifiers associated with the set of predicted measurement results;
transmit, based at least in part on the indication of the one or more differences, a grant scheduling transmission of a second report; and
receive the second report according to the grant, the second report identifying a mapping of the one or more differences between the first set of beam identifiers and the second set of beam identifiers.

16. The apparatus of claim 15, wherein the instructions are further executable by the at least one processor to cause the network entity to:
determine, based at least in part on the indication of the one or more differences, that one or more beam identifiers in the second set of beam identifiers are different from beam identifiers in the first set of beam identifiers, wherein the one or more differences is based at least in part on the difference of the one or more beam identifiers.

17. The apparatus of claim 15, wherein the instructions are further executable by the at least one processor to cause the network entity to:
determine, based at least in part on the indication of the one or more differences, that beam identifiers in the second set of beam identifiers are in a different order in the first set of beam identifiers, wherein the one or more differences is based at least in part on the different order.

18. The apparatus of claim 15, wherein the first report indicates the first set of beam identifiers without indicating the second set of beam identifiers.

19.-27. (canceled)

28. A method for wireless communication at a user equipment (UE), comprising:
transmitting a first report including a set of measurement results and a set of predicted measurement results, the first report further including an indication of one or more differences between a first set of beam identifiers associated with the set of measurement results and a second set of beam identifiers associated with the set of predicted measurement results;
receiving, based at least in part on the indication of the one or more differences, a grant scheduling transmission of a second report; and
transmitting the second report according to the grant, the second report identifying a mapping of the one or more differences between the first set of beam identifiers and the second set of beam identifiers.

29. The method of claim 28, further comprising:
performing a set of channel performance measurements to obtain the set of measurement results for the first set of beam identifiers;
determining a set of predicted channel performance measurements to obtain the set of measurement results for the second set of beam identifiers; and
identifying the one or more differences between the first set of beam identifiers and the second set of beam identifiers, wherein a bit or flag in the first report is set to a value to indicate that the one or more differences have been identified.

30. (canceled)
